(19) United States
(12) Patent Application Publication
(10) Pub. No.: US 2009/0023090 A1
(43) Pub. Date: Jan. 22, 2009

(54) SUPPORT FOR IMAGE RECORDING MATERIAL, METHOD OF PRODUCING THE SAME, AND IMAGE RECORDING MATERIAL AND IMAGE RECORDING METHOD USING THE SAME

(75) Inventors: Shinji Fujimoto, Shizuoka (JP); Kazuhito Miyake, Shizuoka (JP); Ashita Murai, Shizuoka (JP); Ryuichi Katsumoto, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION

(21) Appl. No.: 11/908,360

(22) PCT Filed: Jan. 17, 2006
(86) PCT No.: PCT/JP2006/300532

§ 371 Date: Sep. 11, 2007

(30) Foreign Application Priority Data
Mar. 11, 2005 (JP) 2005-070047

(51) Int. Cl. G03G 13/20; H05H 1/46; B05D 5/00; B05D 3/08; B32B 27/10; B05D 3/02; B05D 3/06

(52) U.S. Cl. 430/124.15; 427/536; 427/209; 427/555; 427/557; 430/124.3; 430/124.13; 428/513

(57) ABSTRACT

The present invention provides a support for image recording material etc. that can record high-quality images far from occurrences of blister, uneven recording or uneven fixing.

In order to attain the object, a support for image recording material is provided that comprises a raw paper, and at least one polyolefin resin layer on both sides of the raw paper, wherein two or more polyolefin resin layers are disposed at the front side where an image recording layer is to be disposed, polypropylene resin is included within at least one polyolefin resin layer at the front side other than the outermost polyolefin resin layer at the front side, and the content A (% by mass) of polypropylene resin within the at least one polyolefin resin layer at the front side other than the outermost polyolefin resin layer is higher than the content B (% by mass) of polypropylene resin within the outermost polyolefin resin layer at the front side. Preferably, the support for image recording material is used for recording an image by way of at least one of recording by heating, development by heating, and fixing by heating.

### TECHNICAL FIELD

The present invention relates to supports for image recording material that can record high-quality images far from occurrences of blister, uneven recording or uneven fixing, methods for producing the same, and image recording material and image recording methods that utilize the same.

### BACKGROUND ART

Raw paper, synthetic paper, synthetic resin sheet, coated paper, laminate paper, etc. have been used conventionally as supports for various image forming materials such as electrophotographic material, heat-sensitive material, ink-jet recording material, sublimation transfer material, heat development material, silver salt photographic material, heat transfer material, etc.; in particular, coated paper and laminate paper have been favorably used.

Supports for image forming material have been proposed, for example, in which at least one resin-coated layer is provided on both sides of raw paper (see Patent Literatures 1 to 5).

When these supports for image recording material are used for electrophotographic material, heat-sensitive material, or various heat transfer-recording material, however, there often arises such a problem that bubble-like defects (blister) appear at resin-coated layers since gas such as water vapor generates from raw paper in at least one heating step of high temperatures in image recording processes. There is also such a problem that highly heat-resistant material for the resin coated layers of supports for image recording material tends to result in uneven recording or uneven fixing due to poor conformability.

Therefore, such a support for image recording material has not been provided yet that has at least one polymer coated layer on both sides of raw paper and can record high-quality images far from occurrences of blister, uneven recording or uneven fixing; thus prompt production thereof is desired currently.

Patent Literature 1: Japanese Patent Application Laid-Open (JP-A) No. 07-120868

Patent Literature 2: JP-A No. 07-270969

Patent Literature 3: JP-A No. 09-146218

Patent Literature 4: JP-A No. 2000-10327

Patent Literature 5: JP-A No. 2002-351121

### DISCLOSURE OF THE INVENTION

The present invention aims to solve the problems in the prior art described above and to attain the following objects. That is, it is an object of the present invention to provide a support for image recording material that can record high-quality images far from occurrences of blister, uneven recording or uneven fixing, a method for producing the same, and image recording material and image recording methods that utilize the support for image recording material.

The objects described above may be attained by the present invention as follows:

<1> A support for image recording material, comprising:
a raw paper, and
at least one polyolefin resin layer on both sides of the raw paper,

wherein two or more polyolefin resin layers are disposed at the front side where an image recording layer is to be disposed,

polypropylene resin is included within at least one polyolefin resin layer at the front side other than the outermost polyolefin resin layer at the front side, and

the content A (% by mass) of polypropylene resin within the at least one polyolefin resin layer at the front side other than the outermost polyolefin resin layer is higher than the content B (% by mass) of polypropylene resin within the outermost polyolefin resin layer at the front side.

<2> The support for image recording material according to <1>, used for recording an image by way of at least one of recording by heating, development by heating, and fixing by heating.
<3> The support for image recording material according to <1> or <2>, wherein the content A (% by mass) of polypropylene resin is higher than the content B (% by mass) of polypropylene resin by 10% by mass or more.
<4> The support for image recording material according to any one of <1> to <3>, wherein the content A (% by mass) of polypropylene resin, within the polyolefin resin layer at the front side other than the outermost polyolefin resin layer at the front side, is 30% by mass or more.
<5> The support for image recording material according to any one of <1> to <4>, wherein the film mass of the polyolefin resin layer at the front side, containing the polypropylene resin other than the outermost polyolefin resin layer at the front side, is 10 g/m² or more.
<6> The support for image recording material according to any one of <1> to <5>, wherein the polypropylene resin has a melt flow rate of 18 g/10 minutes to 50 g/10 minutes and a resin density of 0.890 or more.
<7> The support for image recording material according to any one of <1> to <6>, wherein at least one of the polyolefin resin layers contain at least one of organic pigments and inorganic pigments.
<8> A method of producing the support for image recording material according to any one of <1> to <7>, comprising:

a surface-treating step for treating both sides of the raw paper at an output of no less than 0.010 kW/m²/min by way of corona discharge, plasma, or flame treatment, and

a melt-extrusion step for melting and extruding the polyolefin resin onto both sides of the surface-treated raw paper.

<9> The method of producing the support for image recording material according to <8>, wherein the temperature at melting and extruding the polyolefin resin is 280° C. to 315° C. and ozone gas is applied at a concentration of 10 g/m³ to 50 g/m³ onto the raw-paper side of the melting and extruding film, in the melt-extrusion step.
<10> An image recording material, comprising the support for image recording material according to any one of <1> to <7>, and an image recording layer on the support.
<11> The image recording material according to <10>, subjected to at least one of recording by heating, development by heating, and fixing by heating.
<12> The image recording material according to <10> or <11>, selected from electrophotographic material, heat-sensitive material, sublimation transfer material, heat transfer material, heat development material, silver salt photographic material, and ink-jet recording material.
<13> An image recording method, comprising an image recording step to record an image by way of heating a heat-sensitive recording material that comprises at least a heat-sensitive recording layer on the support for image recording material according to any one of <1> to <7>, by use of thermal heads and laser lights.
<14> An image recording method, comprising:

a latent image-recording step, in which a heat-development material, comprising the support for image recording material according to any one of <1> to <7> and at least one of a photosensitive heat-sensitive recording layer and a heat-development photosensitive layer on the support, is exposed to record a latent image, and

a heat development step, in which the exposed heat-development material is heated by use one of heating rollers, heating belts, plate heaters, thermal heads, laser lights, and combinations thereof to develop the latent image.

<15> An image recording method, comprising:

a toner image-forming step, in which a toner image is formed on the electrophotographic material that comprises the support for image recording material according to any one of <1> to <7> and a toner-image receiving layer, and

a heat fixing step, in which the toner image is fixed through heating by use of one of fixing rollers, fixing belts, and combinations thereof.

<16> An image recording method, comprising:

a toner image-forming step, in which a toner image is formed on the electrophotographic material that comprises the support for image recording material according to any one of <1> to <7> and a toner-image receiving layer, and

an image-surface smoothing-fixing step, in which the surface of the toner image is smoothed.

<17> The image recording method according to <16>, wherein the toner image is heated, pressed, cooled and peeled using an apparatus, configured to fix the toner image and to smooth the toner image surface, that is equipped with a heating-pressurizing unit, a belt, and a cooling unit, in the image-surface smoothing-fixing step.
<18> The image recording method according to <16>, wherein a layer containing fluorocarbon siloxane rubber is disposed at the surface of the belt.
<19> The image recording method according to <17>, wherein a layer containing silicone rubber is disposed at the surface of the belt, and a layer containing fluorocarbon siloxane rubber is disposed at the surface of the layer containing silicone rubber.
<20> The image recording method according to <18> or <19>, the fluorocarbon siloxane rubber comprises in its backbone chain at least one of perfluoroalkyl ether groups and perfluoroalkyl groups.

The inventive support for image recording material comprises a raw paper, at least one polyolefin resin layer on both sides of the raw paper, wherein two or more polyolefin resin layers are disposed at the front side where an image recording layer is to be disposed, polypropylene resin is included within at least one polyolefin resin layer at the front side other than the outermost polyolefin resin layer at the front side, and the content A (% by mass) of polypropylene resin within the at least one polyolefin resin layer at the front side other than the outermost polyolefin resin layer is higher than the content B (% by mass) of polypropylene resin within the outermost polyolefin resin layer at the front side, thereby high-quality images can be recorded without occurrences of blister, uneven recording or uneven fixing.

The inventive method of producing the support for image recording material comprises a surface-treating step for treating both sides of the raw paper at an output of no less than 0.010 kW/m²/min by way of corona discharge, plasma, or flame treatment, and a melt-extrusion step for melting and extruding the polyolefin resin onto both sides of the surface-treated raw paper.

Consequently, the support for image recording material can be easily produced that can record high-quality images far from occurrences of blister, uneven recording or uneven fixing.

Preferably, in the melt-extrusion step described above, the temperature at melting and extruding the polyolefin resin is 280° C. to 315° C. and ozone gas is applied at a concentration of 10 g/m³ to 50 g/m³ onto the raw-paper side of the melting and extruding film. It is particularly preferable that treatments are carried out at forming the polyolefin resin layer containing the polypropylene resin.

The inventive image recording material comprises the support for image recording material, consequently, high-quality images can be recorded without occurrences of blister, uneven recording or uneven fixing, and the image recording material can be provided that is suited to one or more of electrophotographic material, heat-sensitive material, sublimation transfer material, heat transfer material, heat development material, silver salt photographic material, and ink-jet recording material.

The image recording method, in the first embodiment, comprises an image recording step to record an image through heating, by use of thermal heads and laser lights, a heat-sensitive recording material that comprises at least a heat-sensitive recording layer on the inventive support for image recording material. Consequently, high-quality images can be recorded on the heat-sensitive recording material without occurrences of blister, uneven recording or uneven fixing.

The image recording method, in the second embodiment, comprises a latent image-recording step, in which a heat-development material, comprising the inventive support for image recording material and at least one of a photosensitive heat-sensitive recording layer and a heat-development photosensitive layer on the support, is exposed to record a latent image, and a heat development step, in which the exposed heat-development material is heated by use one of heating rollers, heating belts, plate heaters, thermal heads, laser lights, and combinations thereof to develop the latent image. Consequently, high-quality images can be recorded on the heat-development material without occurrences of blister, uneven recording or uneven fixing.

The image recording method, in the third embodiment, comprises a toner image-forming step, in which a toner image is formed on the electrophotographic material that comprises the inventive support for image recording material and a toner-image receiving layer, and a heat fixing step, in which to fix the toner image through heating by use of one of fixing rollers, fixing belts, or combinations thereof. Consequently, high-quality images can be recorded on the electrophotographic material without occurrences of blister, uneven recording or uneven fixing.

The image recording method, in the forth embodiment, comprises a toner image-forming step, in which a toner image is formed on the electrophotographic material that comprises the inventive support for image recording material a toner-image receiving layer, and an image-surface smoothing-fixing step, in which the surface of the toner image is smoothed. Consequently, high-quality images can be recorded on the electrophotographic material without occurrences of blister, uneven recording or uneven fixing.

The present invention can solve the problems in the prior art, that is, provided are the support for image recording material capable of recording high-quality images without occurrences of blister, uneven recording or uneven fixing, method of producing the same, the image recording material that utilizes the inventive support for image recording material and can record high-quality images, and method of producing the same.

### BRIEF DESCRIPTION OF DRAWINGS

FIG. 1 is an exemplary schematic view that shows a device configured to fix a toner image and to smooth the toner image surface.

FIG. 2 is an exemplary schematic view that shows an image forming apparatus.

FIG. 3 is an exemplary schematic view that shows a device configured to fix a toner image and to smooth the toner image surface, equipped into the apparatus of FIG. 2.

### BEST MODE FOR CARRYING OUT THE INVENTION

### Support for Image Recording Material

The inventive support for image recording material comprises a raw paper, at least one polyolefin resin layer on both sides of the raw paper, wherein two or more polyolefin resin layers are disposed at the front side where an image recording layer is to be disposed, and optionally other layers as required.

The support for image recording material can be advantageously used for recording images by way of at least one of recording by heating, development by heating, and fixing by heating.

### Raw Paper

The raw paper may be properly selected depending on the application; specific examples thereof include the high quality paper described in the literature “Basis of Photographic Technology-silver halide photograph, edited by The Society of Photographic Science and Technology of Japan, published by Corona Publishing Co., 1979, pp. 223-224”.

In order to provide the raw paper with a desirable center-line average roughness on the surface, it is preferred that the raw paper is produced, as described in JP-A No. 58-68037, using a pulp fiber having a fiber length distribution in which a total of a 24 mesh screen remnant and a 42 mesh screen remnant is from 20% by mass to 45% by mass and a 24 mesh screen remnant is 5% by mass or less, based on the mass of all pulp fibers. The center-line average roughness of the raw paper can also be controlled by subjecting the raw paper to a surface treatment by applying the heat and pressure using a machine calendar or a super calendar.

The raw paper may be properly selected from conventional ones suited to supports; examples thereof include natural pulp such as of conifer and broadleaf trees, and mixtures of natural pulp and synthetic pulp.

The pulp for the raw paper is preferably broadleaf tree kraft pulp (LBKP), bleached conifer kraft pulp (NBKP) or broadleaf tree sulfite pulp (LBSP), in view of the surface smoothness, rigidity and dimension stability (curl property) of the raw paper. Beaters or refiners may be used for beating the pulp.

The Canada Standard Filtered Water Degree of the pulp is preferably 200 to 440 ml C.S.F., and more preferably 250 to 380 ml C.S.F. since paper shrinkage can be controlled in the paper making process.

Various additives such as fillers, dry paper reinforcers, sizing agents, wet paper reinforcers, fixing agents, pH regulators, pitch control agents, slime control agents or other agents may be optionally added to the pulp slurry (hereafter sometimes referred to as “pulp paper material”) which is obtained after beating the pulp.

Examples of the fillers include calcium carbonate, clay, kaolin, white clay, talc, titanium oxide, diatomaceous earth, barium sulfate, aluminum hydroxide, magnesium hydroxide, calcinated clay, calcinated kaolin, delaminated kaolin, heavy calcium carbonate, light calcium carbonate, magnesium carbonate, barium carbonate, zinc oxide, silicon oxide, amorphous silica, aluminum hydroxide, calcium hydroxide, zinc hydroxide, urea-formaldehyde resins, polystyrene resins, phenol resins and hollow fine particles.

The dry paper reinforcer may be properly selected from conventional ones; examples thereof include cationic starch, cationic polyacrylamide, anionic polyacrylamide, amphoteric polyacrylamide and carboxy-modified polyvinyl alcohol.

The sizing agent may be properly selected from conventional ones; examples thereof include higher fatty acid salts; rosin derivatives such as rosin and maleic rosin; paraffin wax, alkyl ketene dimer, alkenyl succinic anhydride (ASA); and higher fatty acid such as epoxidized fatty amide.

The wet paper reinforcers may be properly selected from conventional ones; examples thereof include polyamine polyamide epichlorohydrin, melamine resins, urea resins, and epoxidized polyamide resins.

Examples of the fixing agents include polyvalent metal salts such as aluminum sulfate and aluminum chloride; basic aluminum compounds such as sodium aluminate, basic aluminum chloride and basic polyaluminum hydroxide; polyvalent metal compounds such as ferrous sulfate and ferric sulfate; starch, processed starch, polyacrylamide, urea resins, melamine resins, epoxy resins, polyamide resins, polyamine resins, polyethylene imine, vegetable gum; water-soluble polymers such as polyethylene oxide; cationic polymers such as cationic starch; dispersions of hydrophilic crosslinking polymer particles; and various compounds such as derivatives and modified products thereof.

The pH regulator may be properly selected from conventional ones; examples thereof include caustic soda and sodium carbonate.

The other agents may be properly selected from conventional ones; examples thereof include defoaming agents, dyes, slime control agents and fluorescent whitening agents.

The pulp slurry may contain a flexibilizer as required. The flexibilizer may be properly selected from conventional ones; examples thereof include those described in the literature “Paper and Paper Treatment Manual, published by Shiyaku Time Co., 1980, pp. 554-555”.

These various additives may be used alone or in combination of two or more. The content of these various additives included into the pulp paper material, which may be properly selected depending on the application, is typically 0.1% by mass to 1.0% by mass.

The pulp paper material, which is optionally prepared by incorporating the various additives into the pulp slurry, is subjected to the papermaking using paper machines such as manual paper machines, Fourdrinier (long-net) paper machines, round-net paper machines, twin-wire machines or combination machines, and the resulting product is dried to produce the raw paper. The resulting raw paper may be optionally subjected to surface sizing-treatment, before or after the drying of the resulting paper.

The treating liquid used for the surface sizing treatment may be properly selected depending on the application; examples of compounds in the treating liquid are water-soluble polymers, waterproof compounds, pigments, dyes and fluorescent whitening agents.

The water-soluble polymer may be properly selected from conventional ones; examples thereof include cationic starch, oxidized starch, polyvinyl alcohol, carboxy-modified polyvinyl alcohol, carboxymethylcellulose, hydroxyethylcellulose, cellulose sulfate, gelatin, casein, sodium polyacrylate, sodium salts of styrene-maleic anhydride copolymer and sodium salts of polystyrene sulfonic acid.

The waterproof compound may be properly selected from conventional ones; examples thereof include latexes and emulsions such as of styrene-butadiene copolymers, ethylene-vinyl acetate copolymers, polyethylene and vinylidene chloride copolymer; and polyamide polyamine epichlorohydrin and synthetic waxes.

The pigment may be properly selected from conventional ones; examples thereof include calcium carbonate, clay, kaolin, talc, barium sulfate and titanium oxide.

From the viewpoint of improving stiffness and dimension stability (curling properties) of the raw paper, it is preferred that the raw paper has a ratio (Ea/Eb) between longitudinal Young's modulus (Ea) and lateral Young's modulus (Eb) in a range of 1.5 to 2.0. When the ratio (Ea/Eb) is less than 1.5 or more than 2.0, the stiffness or the curling properties of the electrophotographic material may be easily impaired, and the transportability of the electrophotographic material is hindered undesirably.

It has been demonstrated that the paper “nerve” depends on the pulp beating processes and the elastic modulus of paper produced by papermaking after the pulp beating can be used as an important index of the paper “nerve”. The elastic modulus of paper can be calculated based on the relation between dynamic elastic modulus and density and measurement of an acoustic velocity in the paper using an ultrasonic oscillator, specifically from the following equation:

E=ρc²(1−n²)

in which “E” represents a dynamic elastic modulus, “ρ” represents the density of the paper, “c” represents the acoustic velocity in the paper, and “n” represents Poisson's ratio.

Since “n” is about 0.2 in ordinary papers, the calculation from the following equation is allowable.

E=ρc²

As such, the measurements of density and acoustic velocity of a paper may easily result in the elastic modulus. The acoustic velocity may be measured by Sonic Tester SST-110 (by Nomura Shoji Co.), for example.

The thickness of the raw paper may be properly selected depending on the application; the thickness is preferably 30 to 500 μm, more preferably 50 to 300 μm, and still more preferably 100 to 250 μm. The basis weight may also be properly selected depending on the application; the thickness is preferably 50 to 250 g/m², and more preferably 100 to 200 g/m².

The raw paper is preferably calender-treated such that metal rollers contact with the surface of raw paper on which images being recorded.

The surface temperature of the metal rollers is preferably 100° C. or higher, more preferably 150° C. or higher, and still more preferably 200° C. or higher. The maximum surface temperature of metal rollers may be properly selected depending on the application; typically, the maximum temperature is about 300° C.

The nip pressure at the calender treatment may be properly selected depending on the application; preferably, the pressure is 100 kN/cm² or more, and more preferably 100 kN/cm² to 600 kN/cm².

The calender used in the treatment described above may be properly selected depending on the application; examples thereof include soft calender rollers in combination of a metal roller and a synthetic resin roller and machine calender rollers containing a pair of metal rollers. Among these, calenders having a soft calender roller are preferable, and particularly preferable are shoe calenders consisting of a metal roll and a shoe roll through a synthetic resin belt since the nip width is large and thus the contacting area between the cast-coat layer of raw paper and the roll is increased.

### Polyolefin Resin Layer

At least one polyolefin layer is disposed on both sides of the raw paper, and at least two polyolefin resin layers, which being disposed at the front side of the raw paper where an image recording layer is to be disposed, are comprised of an outermost polyolefin resin layer at the front side most distal from the raw paper and a polyolefin resin layer at the front side other than the outermost polyolefin resin layer.

When the polyolefin resin layer at the front side is formed of two-layer laminate of an upper polyolefin resin layer and a lower polyolefin resin layer on the raw paper in this order, the upper polyolefin resin layer is the outermost polyolefin resin layer at the front side and the lower polyolefin resin layer is the polyolefin resin layer at the front side other than the outermost polyolefin resin layer.

When the polyolefin resin layer at the front side is formed of three-layer laminate of an upper polyolefin resin layer, an intermediate polyolefin resin layer and a lower polyolefin resin layer on the raw paper in this order, the upper polyolefin resin layer is the outermost polyolefin resin layer at the front side and the lower polyolefin resin layer and the intermediate polyolefin resin layer are the polyolefin resin layers at the front side other than the outermost polyolefin resin layer.

The present invention has a feature that polypropylene resin is included, in terms of the front side, within at least one polyolefin resin layer other than the outermost polyolefin resin layer, and the content A (% by mass) of polypropylene resin within the at least one polyolefin resin layer other than the outermost polyolefin resin layer is higher than the content B (% by mass) of polypropylene resin within the outermost polyolefin resin layer. Consequently, high quality images can be recorded that are far from occurrences of blister upon recording, developing or fixing images due to heating, and free from occurrences of uneven recording or uneven fixing.

It is preferred that the content A (% by mass) of polypropylene resin is higher than the content B (% by mass) of polypropylene resin by no less than 10% by mass, more preferably no less than 30% by mass. When the difference is below 10% by mass between the content A and content B, the edge void and the blister tend to be out of well-balanced and the image quality may be inferior.

It is preferred that the film mass of the polyolefin resin layer at the front side containing the polypropylene resin other than the outermost polyolefin resin layer is no less than 10 g/m², more preferably no less than 15 g/m². The film mass of below 10 g/m² tends to cause the blister and degrade the image quality. The upper limit of the film mass is preferably 50 g/m²; the film mass of above 50 g/m² may lower the productivity since the output amount of melted polyolefin resin is limited.

It is preferred that the content A of polypropylene resin is no less than 30% by mass, more preferably no less than 50% by mass, in terms of the polyolefin resin layer at the front side containing the polypropylene resin other than the outermost polyolefin resin layer.

The content A of polypropylene resin of less than 30% by mass may lower the temperature capable of resisting the blister, which possibly occurring the blister at lower temperatures.

As such, it is particularly preferred that the film mass of the polyolefin resin layer at the front side containing the polypropylene resin other than the outermost polyolefin resin layer is no less than 15 g/m², and also the content A of polypropylene resin at the layer is no less than 30% by mass, which can lead to high quality images with more excellent blister resistance and higher efficiency to prevent uneven recording or uneven fixing.

It is preferred that the film mass of the outermost polyolefin resin layer at the front side is 5 to 50 g/m², more preferably 10 to 30 g/m², most preferably 15 to 30 g/m². The film mass of below 5 g/m² may make difficult to take the effect of thermally plasticized polyolefin resin layer and degrade heat-fixability. The film mass of above 50 g/m² may lower the productivity since the output amount of melted polyolefin resin is limited.

The polypropylene resin preferably has a melt flow rate of 18 to 50 g/10 minutes and a resin density of no less than 0.890, more preferably a melt flow rate of 30 to 50 g/10 minutes and a resin density of no less than 0.900. The melt flow rate of below 18 g/10 minutes and/or the resin density of below 0.890 may lower the adhesive strength between the raw paper and the polyolefin resin layer.

When a polyolefin resin layer is provided at the back side of the raw paper (hereinafter sometimes referred to as “polyolefin resin layer at the back side”), the film mass of the polyolefin resin layer at the back side, which may be properly selected depending on the application, is preferably adjusted so as to make the curl flat in the final configuration.

The polyolefin resin in the polyolefin resin layer is preferably exemplified by polyethylene resins, polypropylene resins, blends of polypropylene resins and polyethylene resins, high-density polyethylene resins, and blends of high-density polyethylene resins and low-density polyethylene resins.

It is preferred among these that the outermost polyolefin resin layer at the front side is formed from a low-density polyethylene resin having a resin density of no more than 0.930 g/cm³, more preferably no more than 0.925 g/cm³.

It is particularly preferred that the at least one polyolefin resin layer at the front side containing the polypropylene resin other than the outermost polyolefin resin layer at the front side is formed from a polypropylene resin or a blend of a polypropylene resin and a low-density polyethylene resin.

It is preferred that at least one of the polyolefin resin layers at the front or the back side contains at least one of organic pigments and inorganic pigments.

The organic pigment may be properly selected from conventional ones; examples thereof include ultramarine, Silurian blue, phthalocyanine blue, cobalt violet, fast violet and manganese violet.

The inorganic pigment may be properly selected from conventional ones; examples thereof include titanium dioxide, calcium carbonate, talc, stearic acid amide and zinc stearate. Among these, titanium dioxide is preferable. The titanium dioxide may be anatase or rutile. The content of the titanium dioxide in the polyolefin resin layer is preferably 5 to 30% by mass.

### Method of Producing Support for Image Recording Material

The method of producing the support for image recording material may be properly selected depending on the application; for example, the support may be produced by way of forming a polyolefin resin layer on both sides of the raw paper in accordance with the processes described below.

The method of forming the polyolefin resin layer may be properly selected depending on the application; the polyolefin resin layer may be typically formed by usual laminating processes, sequential laminating processes, or laminating processes by use of single-layer or multi-layer extrusion dies such as feet-block dies, multi-manifold dies, and multi-slot dies or laminators, or co-extrusion coating processes under simultaneous extrusion of multi-layer. The shape of the single-layer or multi-layer extrusion dies may be properly selected depending on the application; and preferably exemplified by T-dies, coat hanger dies, etc. Preferably, the polyolefin resin layer is formed in accordance with the inventive production method.

The method of producing the support for image recording material preferably comprises a surface-treating step for treating both sides of the raw paper at an output of no less than 0.010 kW/m²/min by way of corona discharge, plasma, or flame treatments, a melt-extrusion step for melting and extruding the polyolefin resin onto both sides of the surface-treated raw paper, and optional other steps.

The corona discharge, plasma, or flame treatments in the surface-treating step may oxidize the surface of raw paper thereby to improve the contact between the raw paper and the polyolefin resin layer. The output of less than 0.010 kW/m²/min at the surface treatment may result in poor contact between the raw paper and the polyolefin resin layer.

It is preferred in the melt-extrusion step that the temperature at melting and extruding the polyolefin resin is 280° C. to 315° C. and ozone gas is applied at a concentration of 10 to 50 g/m³ onto the raw-paper side of the melting and extruding film. Consequently, contact, coating ability, etc may be improved between the raw paper and the polyolefin resin layer, the handling ability may be enhanced in the production processes, the polyolefin resin layer may be efficiently formed on the raw paper with a uniform thickness, and the handling ability of the resulting product may be enhanced.

When the temperature at the melting and extruding step is below 280° C., the melt of the polyolefin resin may be insufficient, which possibly disturbing to form uniform polyolefin resin layer on the raw paper, and when the temperature is above 315° C., the resin tends to heat-decompose thus coloring the polyolefin resin layer and also streaks tend to occur due to discomposed matters.

The ozone concentration of below 10 g/m³ in the ozone gas may result in insufficient adhesive strength between the raw paper and the polyolefin resin layer, and the concentration of above 50 g/m³ may make difficult to maintain safe production environment.

The inventive support for image recording material produced as described above may allow to record high-quality images far from occurrences of blister, uneven recording or uneven fixing, and thus may be applied favorably to various applications such as electrophotographic material, heat-sensitive material, sublimation transfer material, heat transfer material, heat development material, silver salt photographic material and ink-jet recording material.

### Image Recording Material

The inventive image recording material comprises the inventive support for image recording material, an image recording layer on the support, and optionally the other layers as required. The support for image recording material is explained in detail above.

It is preferred that the image recording material is subjected to at least one of recording by heating, development by heating, and fixing by heating.

Preferably, the recording by heating is carried out by use of thermal heads or laser lights; the development by heating is carried out by use of heating rollers, heating belts, plate heaters, thermal heads, laser lights, or combinations thereof, preferably, the fixing by heating is carried out by use of fixing rollers, fixing belts, and combinations thereof.

The image recording material depends on the applications or species thereof and is exemplified by electrophotographic material, heat-sensitive material, sublimation transfer material, heat transfer material, heat development material, silver salt photographic material and ink-jet recording material. These image recording materials will be explained in the following.

### Electrophotographic Material

The electrophotographic material comprises the inventive support for image recording material, at least a toner image-receiving layer disposed on the support as an image recording layer, and optionally other layers suitably selected as required, such as a surface protective layer, back layer, intermediate layer, undercoat layer, cushion layer, charge-control (preventing) layer, reflective layer, tint-control layer, shelf stability-improving layer, adhesion-proof layer, anti-curling layer and smoothing layer. These layers may be of mono-layer structure or laminate structure.

### Toner Image-Receiving Layer

The toner image-receiving layer is disposed to receive color toners and black toner to form images. The toner image-receiving layer functions to receive image-forming toners from a developing drum or an intermediate transfer member by action of electrostatic charge and/or pressure in an image transfer step, and to fix the images by action of heat and/or pressure in a fixing step.

The toner image-receiving layer preferably has a light transmittance of no more than 78% in view of taking visual appearance of the inventive electrophotographic material similarly as that of photography; the light transmittance is more preferably no more than 73%, still more preferably no more than 72%.

The light transmittance of the toner image-receiving layer can be measured, for example, by way of forming another coating layer separately in the same thickness on a polyethylene terephthalate film having a thickness of 100 μm, and measuring the light transmittance of the coating layer using a haze meter of direct-reading type (HGM-2DP, by Suga Tester Co.).

The toner-image receiving layer may contain at least a thermoplastic resin, and also various additives, for improving thermodynamic properties of the toner image-receiving layer, such as a releasing agent, plasticizer, colorant, filler, crosslinking agent, charge control agent, emulsifier, and dispersing agent.

### Thermoplastic Resin

The thermoplastic resin may be properly selected depending on the application; examples thereof include (1) polyolefin resins, (2) polystyrene resins, (3) acrylic resins, (4) polyvinyl acetates and derivatives thereof, (5) polyamide resins, (6) polyester resins, (7) polycarbonate resins, (8) polyether resins or acetal resins, and (9) other resins. These thermoplastic resins may be used alone or in combination of two or more. Among these, styrene resins, acrylic resins and polyester resins having a large cohesive energy are preferable in view of embedding toners into resins.

Examples of the polyolefin resins (1) include polyolefin resins such as polyethylene and polypropylene; and copolymer resins of olefins such as ethylene and propylene with other vinyl monomers. Examples of such copolymer resins include ethylene-vinyl acetate copolymers and ionomer resins olefins with acrylic acid or methacrylic acid. Examples of the polyolefin resin derivatives include chlorinated polyethylene and chlorosulfonated polyethylene.

Examples of the polystyrene resins (2) include polystyrene resin, styrene-isobutylene copolymers, acrylonitrile-styrene copolymers (AS resin), acrylonitrile-butadiene-styrene copolymers (ABS resin) and polystyrene-maleic anhydride resins.

Examples of the acrylic resins (3) include polyacrylic acid and esters thereof, polymethacrylic acid and esters thereof, polyacrylonitrile and polyacrylamide.

Examples of the esters of polyacrylic acid include homopolymers and copolymers of esters of acrylic acids. Examples of the esters of acrylic acids include methyl acrylate, ethyl acrylate, n-butyl acrylate, isobutyl acrylate, dodecyl acrylate, n-octyl acrylate, 2-ethylhexyl acrylate, 2-chloroethyl acrylate, phenyl acrylate, and α-chloromethyl acrylate.

Examples of the esters of polymethacrylic acids include homopolymers and copolymers of esters of methacrylic acids. Examples of the esters of methacrylic acid include methyl methacrylate, ethyl methacrylate and butyl methacrylate.

Examples of the polyvinyl acetate and derivatives thereof (4) include polyvinyl acetate, polyvinyl alcohol produced by saponifying the polyvinyl acetate and polyvinylacetal resins produced by reacting the polyvinyl alcohol with an aldehyde (e.g., formaldehyde, acetaldehyde and butyraldehyde).

The polyamide resins (5) are polycondensates of a diamine and a dibasic acid and examples thereof include 6-nylon and 6,6-nylon.

The polyester resins (6) may be produced by a polycondensation reaction between an acid component and an alcohol component. The acid component may be properly selected depending on the application; examples thereof include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecenylsuccinic acid, isododecenylsuccinic acid, n-octenylsuccinic acid, n-octenylsuccinic acid, isooctenylsuccinic acid, isooctylsuccinic acid, trimellitic acid, and pyromellitic acid; and acid anhydrides thereof or lower alkyl esters thereof.

The alcohol component may be properly selected depending on the application; preferable examples thereof are divalent alcohols. Specific examples aliphatic diols include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, propylene glycol and polytetramethylene glycol. Examples of alkylene oxide adduct of bisphenol A include polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane.

The polycarbonate resin (7) is typically polycarbonate esters produced from bisphenol A and phosgene.

Examples of the polyether resin (or the acetal resin) (8) include polyether resins such as polyethylene oxide and polypropylene oxide or acetal resins produced by ring opening polymerization such as polyoxymethylene.

The other resins (9) include polyurethane resins produced by an addition polymerization.

The thermoplastic resin is preferably one capable of satisfying the properties of the toner image-receiving layer at the stage when the toner image-receiving layer is formed, more preferably, one capable of satisfying the properties of the toner image-receiving layer by the resin itself, it is also preferable to use two or more resins which are different in the physical properties of the image-receiving layer.

The thermoplastic resin preferably has a molecular mass greater than that of the thermoplastic resin used in the toner. In some cases, the relation of the molecular mass is not necessarily preferable in relation to thermodynamic properties of the thermoplastic resin used in the toner and the polymer for image-receiving layer. For example, when the softening temperature of the polymer for image-receiving layer is higher than that of the thermoplastic resin used in the toner, the molecular mass of the polymer for image-receiving layer is preferably equal to or smaller than that of the thermoplastic resin used in the toner.

The thermoplastic resin in the toner image-receiving layer is preferably a mixture of resins equivalent in terms of composition and differ in terms of the average molecular mass each other. The relation of molecular mass is preferably that disclosed in Japanese Patent Application Laid-Open (JP-A) No. 08-334915.

The molecular mass distribution of the polymer for toner image-receiving layer is preferably wider than that of the thermoplastic resin used in the toner.

It is preferable that the thermoplastic resin in the toner image-receiving layer satisfies the physical properties disclosed in JP-A Nos. 05-127413, 08-194394, 08-334915, 08-334916, 09-171265 and 10-221877.

The thermoplastic resin for the toner image-receiving layer is preferably an aqueous resin such as water-dispersible polymers and water-soluble polymers from the viewpoint that (i) environmental suitability and working suitability are adequate due to no discharge of organic solvents in coating and drying steps, (ii) releasing agents such as waxes are often hardly-soluble in solvents at room temperature, thus releasing agents are typically dispersed in a solvent such as water and organic before use, and water-dispersed releasing agents are typically stable and favorable for production processes, and also aqueous coating tends to make waxes bleed out to the surface at coating and drying steps, thus effects of releasing agents such as antioffset properties and adhesion resistance are obtainable.

The aqueous resin should not be limited as to the composition, binding structure, molecular structure, molecular mass, molecular mass distribution, form, etc., as long as the aqueous resin is one of water dispersible polymers and water-soluble polymers, and may be suitably selected depending on the application. Examples of aqueous groups of the polymer include sulfonic groups, hydroxyl groups, carboxylic acid groups, amino groups, amide groups and ether groups.

The water dispersible polymer may be water dispersible polymers or emulsions of the thermoplastic resins (1) to (9) described above, copolymers, mixtures, or cation-modified products thereof, the water dispersible polymer may be used alone in combination.

The water dispersible polymer may be suitably synthesized or commercially available. Examples of the commercially available product include water dispersible polyester polymers such as BYRONAL series (TOYOBO Co.), PESRESIN A series (Takamatsu Oil & Fat Co.), TAFTON UE series (KAO Corporation), POLYESTER WR series (Nippon Synthetic Chemical Industry Co.) and ELIETEL series (UNITIKA Ltd.); and water dispersible acrylic resins such as HIROS XE, KE and PE series (by SEIKO PMC CORPORATION) and JULIMER ET series (Nihon Junyaku Co.).

The water dispersible emulsion may be suitably selected depending on the application; examples thereof include water dispersible polyurethane emulsions, water dispersible polyester emulsions, chloroprene emulsions, styrene-butadiene emulsions, nitrile-butadiene emulsions, butadiene emulsions, butadiene emulsions, vinylchloride emulsions, vinylpyridine-styrene-butadiene emulsions, polybutene emulsions, polyethylene emulsions, vinylacetate emulsions, ethylene-vinylacetate emulsions, vinylidene chloride emulsions and methyl methacrylate-butadiene emulsions. Among these, water dispersible polyester emulsions are particularly preferable.

The water dispersible polyester emulsion is preferably self-dispersible aqueous polyester emulsions; among these, carboxyl group-containing self-dispersible aqueous polyester emulsions are particularly preferable. The self-dispersible aqueous polyester emulsion means an aqueous emulsion containing a polyester resin that is self-dispersible in an aqueous solvent without using an emulsifier or the like. The carboxyl group-containing self-dispersible aqueous polyester resin emulsion means an aqueous emulsion containing a polyester resin which contains a carboxyl group as a hydrophilic group and is self-dispersible in an aqueous solvent.

The self-water dispersible polyester emulsion is preferably one that satisfies the following properties (1) to (4). The self-water dispersible polyester emulsion contains no surfactant, thus exhibits low moisture-absorption even under high-humidity, decreases scarcely its softening point regardless of moisture, and is far from offset in fixing steps and inter-sheet adhesion during storage. Such a condition of water dispersion may also be advantageous in terms of environment and workability. Further, the polyester resin, which easily taking a molecular structure with a high-cohesive energy, may provide a sufficient hardness in storage environment, meanwhile allow to embed the toner into the image-receiving layer to attain sufficiently high quality due to a melted condition of low modulus or low viscosity at the electrophotographic fixing steps.

(1) The number average molecular mass (Mn) is preferably 5,000 to 10,000, more preferably 5,000 to 7,000.

(2) The molecular mass distribution (mass average molecular mass (Mw)/number average molecular mass (Mn)) is preferably 4 or less, and more preferably 3 or less.

(3) The glass transition temperature (Tg) is preferably 40° C. to 100° C., more preferably 50° C. to 80° C.

(4) The volume average particle diameter is preferably 20 nm to 200 nm, more preferably 40 nm to 150 mm.

The content of the water-dispersible emulsion in the image-receiving layer is preferably 10 to 90% by mass, more preferably 10 to 70% by mass.

The water-soluble polymer may be properly selected depending on the application as long as having a mass average molecular mass (Mw) of no more than 400,000, and suitably synthesized or commercially available. Examples of the water-soluble polymer include polyvinyl alcohol, carboxy-modified polyvinyl alcohol, carboxy methyl cellulose, hydroxy ethyl cellulose, cellulose sulfate, polyethylene oxide, gelatin, cationic starch, casein, sodium polyacrylate, sodium of styrene-maleic acid anhydride copolymer, and sodium polystyrenesulfonate. Among these, polyethylene oxide is preferable.

Examples of commercially available ones include water soluble polyester such as various Plus Coat (by Gao Chemical Industries) and FINETEX ES series (by Dainippon Ink and Chemicals, Inc.); and water soluble acryls such as JULIMER AT series (by Nihon Junyaku Co.), FINTEX 6161, K-96 (by Dainippon Ink and Chemicals, Inc.) and HIROS NL-1189 and BH-997L (by SEIKO PMC Co.).

In addition, the water soluble polymers are exemplified by those described in “Research Disclosure No. 17643, on page 26”, “Research Disclosure, No. 18716, on page 651”, “Research Disclosure No. 307105, on pp. 873-874”, and JP-A No. 64-13546.

The content of the water soluble polymer in the toner image-receiving layer may be properly selected depending on the application; preferably, the content is 0.5 to 2 g/m².

The thermoplastic resin may be used together with other polymer materials; in such cases, the content of the thermoplastic resin is typically larger than that of other polymer materials.

The content of the thermoplastic resin for the toner image-receiving layer is preferably no less than 10% by mass in the toner image-receiving layer, more preferably no less than 30% by mass, still more preferably no less than 50% by mass, particularly preferably no less than 50 to 90% by mass.

### Releasing Agent

The releasing agent may be incorporated into the toner image-receiving layer to prevent offset of the toner image-receiving layer. The releasing agent may be properly selected depending on the application as long as capable of forming a releasing-agent layer on the toner image-receiving layer through being heated and melted at the fixing temperature then depositing and locally existing through being cooled and solidified.

The releasing agent is exemplified by silicone compounds, fluorine compounds, waxes and matting agents.

The releasing agent may be, for example, those described in “Properties and Applications of Waxes-Revised edition” published by Saiwai Shobo and “Handbook of Silicones” issued by Nikkan Kogyo Shimbun, Ltd. The silicone compounds, fluorine compounds and waxes are also available that are described in Japanese Patent (JP-B) Nos. 2838498, and 2949585, and Japanese Patent Application Laid Open (JP-A) Nos. 59-38581, 04-32380, 50-117433, 52-52640, 5757-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-36210, 07-43940, 07-56387, 07-56390, 07-64335, 07-199681, 07-223362, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 11-44969, 11-65156, 11-73049, and 11-194542. These may be used alone or in combination.

Examples of the silicone compounds include silicone oils, silicone rubbers, silicone fine particles, silicone-modified resins and reactive silicone compounds.

Examples of the silicone oils include unmodified silicone oil, amino-modified silicone oils, carboxy-modified silicone oils, carbinol-modified silicone oils, vinyl-modified silicone oils, epoxy-modified silicone oils, polyether-modified silicone oils, silanol-modified silicone oils, methacryl-modified silicone oils, mercapto-modified silicone oils, alcohol-modified silicone oils, alkyl-modified silicone oils, and fluorine-modified silicone oils.

Examples of the silicone-modified resins include olefin resins, polyester resins, vinyl resins, polyamide resins, cellulose resins, phenoxy resins, vinylchloride-vinylacetate resins, urethane resins, acrylic resins, styrene-acryl resins, and copolymer resins thereof modified with silicone.

The fluorine compound may be properly selected depending on the application; examples thereof include fluorine oils, fluorine rubbers, fluorine-modified resins, fluorine sulfonate compounds, fluorosulfonic acid, fluorine acid compounds or salts thereof, and inorganic fluorides.

The waxes may be classified generally into natural waxes and synthetic waxes. The natural waxes are preferably ones selected from vegetable, animal, mineral, and petroleum waxes; among these, vegetable waxes are particularly preferable. The natural waxes are preferably water-dispersible waxes in terms of compatibility in cases where aqueous resins are used for the toner image-receiving layer.

The vegetable waxes may be properly selected from conventional ones that are commercially available or synthesized. Examples of the vegetable wax include carnauba waxes, castor oils, rapeseed oils, soybean oils, vegetable tallow, cotton waxes, rice waxes, sugarcane waxes, candelilla waxes, Japan waxes and jojoba waxes.

The commercially available carnauba waxes are exemplified by EMUSTAR-0413 (Nippon Seiro Co.) and Cellozol 524 (Chukyo Yushi Co.). The commercially available castor oils are exemplified by purified castor oils (Itoh Oil Chemicals Co.).

Among these, carnauba waxes having a melting point of 70° C. to 95° C. are particularly preferable in view of electrophotographic materials that are superior in offset resistance, adhesion resistance, paper transportability, glossiness and cracking resistance.

The animal waxes may be properly selected from conventional ones; examples thereof include bee waxes, lanolin, whale waxes, whale oils and sheep wool waxes.

The mineral waxes may be properly selected from conventional ones that may be commercially available or synthesized. Examples thereof include montan wax, montan-ester wax, ozokerite and ceresin.

Among these, montan waxes having a melting point of 70° C. to 95° C. are particularly preferable in view of electrophotographic materials can be provided that are superior in offset resistance, adhesion resistance, paper transportability, glossiness and cracking resistance.

The petroleum waxes may be properly selected from conventional ones that may be commercially available or synthesized; examples thereof include paraffin waxes, microcrystalline waxes and petrolatum.

The content of the natural wax in the toner image-receiving layer is preferably 0.1 to 4 g/m², more preferably 0.2 to 2 g/m².

When the content of the natural wax is less than 0.1 g/m², the offset resistance may be insufficient, and when the content is more than 4 g/m², the image quality may be degraded due to the excessive wax.

The melting point of the natural wax is preferably 70° C. to 95° C., and more preferably 75° C. to 90° C. from the viewpoint of the offset resistance and paper transportability.

The synthetic waxes may be classified into synthetic hydrocarbons, modified waxes, hydrogenated waxes, and other fat and fatty oil synthetic waxes. These waxes are preferably water-dispersible waxes in terms of compatibility in cases where aqueous thermoplastic resins are used for the toner image-receiving layer.

Examples of the synthetic hydrocarbon waxes include Fischer-Tropsch waxes and polyethylene waxes. Examples of the fat and fatty oil synthetic waxes include acid amide compounds such as stearic acid amid and acid imide compounds such as phthalic anhydride imide.

The modified waxes may be properly selected depending on the application; examples thereof include amine-modified waxes, acrylic acid-modified waxes, fluorine-modified waxes, olefin-modified waxes, urethane waxes and alcohol waxes.

Examples of the hydrogenated waxes may be properly selected depending on the application; examples thereof include hardened castor oil, castor oil derivatives, stearic acid, lauric aid, myristic acid, palmitic acid, behenyl acid, sebacic acid, undecylenic acid, heptyl acid, maleic acid and highly maleated oils.

The melting point of the releasing agent is preferably 70° C. to 95° C., and more preferably 75° C. to 90° C. from the viewpoint of the offset resistance and paper transportability.

The releasing agent in the toner image-receiving layer may also be derivatives, oxides, purified materials, or mixtures of the substances described above, and may have a reactive substituent.

The content of the releasing agent is preferably 0.1 to 10% by mass based on the mass of the toner image-receiving layer, more preferably 0.3 to 8.0% by mass, still more preferably 0.5 to 5.0% by mass.

When the content of the natural wax is less than 0.1% by mass, the offset resistance and adhesion resistance may be insufficient, and when the content is more than 10% by mass, the image quality may be degraded due to the excessive amount.

### Plasticizer

The plasticizer may be properly selected from those used conventionally for resins depending on the application. The plasticizer may control flowability and/or softening of the toner image-receiving layer by means of heat and/or pressure at fixing the toner.

Examples of the plasticizer are described in “Kagaku Binran (Chemical Handbook), edited by The Chemical Society of Japan, published by Maruzen Co.”, “Plasticizer, Theory and Application, edited by Koichi Murai, published by Saiwai Shobo”, “Volumes 1 and 2 of Studies on Plasticizer, edited by Polymer Chemistry Association”, and “Handbook on Compounding Ingredients for Rubbers and Plastics, edited by Rubber Digest Co.”.

Some plasticizers are described as an organic solvent having a high boiling point or a thermal solvent in some literatures. Examples of the plasticizer include esters such as phthalate esters, phosphorate esters, fatty esters, abietate esters, adipate esters, sebacate esters, azelate esters, benzoate esters, butyrate esters, epoxidized fatty esters, glycolate esters, propionate esters, trimellitate esters, citrate esters, sulfonate esters, carboxylate esters, succinate esters, malate esters, fumarate esters, phthalate esters and stearate esters; amides such as fatty amides and sulfonate amides; ethers, alcohols, lactones and polyethylene oxides, which are described in JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646 and 02-235694 etc. These plasticizers may be incorporated into the resins.

The plasticizer may be polymers of lower molecular masses. It is preferred that the molecular mass of the plasticizer is less than that of the binder resin to be plasticized; preferably, the molecular mass is 15,000 or less, more preferably 5,000 or less. In cases where the plasticizer is a polymer, the polymer is preferably the same type as that of the binder resin to be plasticized. For example, it is preferred that a polyester of lower molecular masses is employed for plasticizing a polyester resin. Oligomers may also be employed for the plasticizer.

In addition, commercially available ones may be employed such as Adekacizer PN-170 and PN-1430 (by Asahi Denka Kogyo Co.); PARAPLEX G-25, G-30 and G-40 (by C. P. Hall Co.); and Ester Gum 8L-JA, Ester R-95, Pentalin 4851, FK 115, 4820, 830, Luisol 28-JA, Picolastic A75, Picotex LC and Crystalex 3085 (by Rika Hercules Co.).

The plasticizer may be optionally used for relaxing the stress and strain, i.e. physical strain such as elastic force and viscosity or strain due to material balance in molecules, main chains, and pendant moieties of binders, when toner particles are embedded into the toner image-receiving layer.

The plasticizer may be finely and microscopically dispersed, phase-separated similarly as a sea-island structure, or mixed and dissolved with other components such as binder resins, in the toner image-receiving layer.

The content of the plasticizer in the toner image-receiving layer is preferably 0.001% by mass to 90% by mass, more preferably 0.1% by mass to 60% by mass, still more preferably 1% by mass to 40% by mass, based on the mass of the toner image-receiving layer.

The plasticizer may be used for controlling slip properties to improve the transportability by reducing the friction, improving the offset at fixing parts to peel the toner or the layer, controlling the curling balance, or adjusting the electrostatic charge to form toner electrostatic images.

### Colorant

The colorant may be properly selected depending on the application; examples thereof include fluorescent whitening agents, white pigments, color pigments, and dyes.

The fluorescent whitening agent may be appropriately selected from conventional ones that have an absorption in near-ultraviolet region and emit a fluorescence of 400 nm to 500 nm; preferable examples are described in “The Chemistry of Synthetic Dyes, Volume V, by K. Veen Rataraman, Chapter 8”. The fluorescent whitening agent may be commercially available or suitably synthesized; examples thereof include stilbene, coumarin, biphenyl, benzoxazoline, naphthalimide, pyrazoline, or carbostyril compounds. Examples of the commercially available ones include white furfar-PSN, PHR, HCS, PCS and B (by Sumitomo Chemicals Co.) and UVITEX-OB (by Ciba-Geigy Co.).

The white pigment may be properly selected from conventional ones depending on the application; examples thereof include inorganic pigments such as titanium oxide and calcium carbonate.

The color pigment may be properly selected from conventional ones; examples thereof include various pigments described in JP-A No. 63-44653, azo pigments, polycyclic pigments, condensed polycyclic pigments, lake pigments, and carbon black.

Examples of the azo pigment include azo lake pigments such as carmine 6B and red 2B; insoluble azo pigments such as monoazo yellow, disazo yellow, pyrazolone orange and Vulcan orange; condensed azo pigments such as chromophthal yellow and chromophthal red.

Examples of the polycyclic pigment include phthalocyanine pigments such as copper phthalocyanine blue and copper phthalocyanine green. Examples of the condensed polycyclic pigment include dioxazine pigments such as dioxazine violet; isoindolinone pigments such as isoindolinone yellow; threne pigments, perylene pigments, perinone pigments and thioindigo pigments.

Examples of the lake pigment include malachite green, rhodamine B, rhodamine G and Victoria blue B. Examples of the inorganic pigment include oxides such as titanium dioxide and iron oxide red; sulfate salts such as precipitated barium sulfate; carbonate salts such as precipitated calcium carbonate; silicate salts such as hydrous silicate salts and anhydrous silicate salts; metal powders such as aluminum powder, bronze powder, zinc powder, chrome yellow and iron blue. These may be used alone or in combination.

The dyes may be properly selected from conventional ones depending on the application; examples thereof include anthraquinone compounds and azo compounds. These dyes may be used alone or in combination.

The water-insoluble dyes are exemplified by vat dyes, disperse dyes, and oil-soluble dyes. Specific examples of the vat dye include C.I. Vat violet 1, C.I. Vat violet 2, C.I. Vat violet 9, C.I. Vat violet 13, C.I. Vat violet 21, C.I. Vat blue 1, C.I. Vat blue 3, C.I. Vat blue 4, C.I. Vat blue 6, C.I. Vat blue 14, C.I. Vat blue 20 and C.I. Vat blue 35. Specific examples of the disperse dye include C.I. disperse violet 1, C.I. disperse violet 4, C.I. disperse violet 10, C.I. disperse blue 3, C.I. disperse blue 7, and C.I. disperse blue 58. Specific examples of the oil-soluble dye include C.I. solvent violet 13, C.I. solvent violet 14, C.I. solvent violet 21, C.I. solvent violet 27, C.I. solvent blue 11, C.I. solvent blue 12, C.I. solvent blue 25 and C.I. solvent blue 55.

Colored couplers used in silver halide photography may also be used as the dye.

The content of the colorant in the toner image-receiving layer is preferably 0.1 to 8 g/m², and more preferably 0.5 to 5 g/m².

The colorant content of less than 0.1 g/m² may lead to excessively high light transmittance at the toner image-receiving layer, and the content of more than 8 g/m² may be undesirable for handling, crazing and/or adhesion resistance.

The content of the pigment is preferably 40% by mass or less, more preferably 30% by mass or less, and still more preferably 20% by mass or less based on the mass of the thermoplastic resin in the toner image-receiving layer.

The filler may be organic or inorganic ones that are conventionally used as reinforcing agents, fillers, or reinforcing agents for binder resins. The filler may be properly selected with reference to “Handbook of Rubber and Plastics Additives, edited by Rubber Digest Co.”, “Plastics Blending Agents—Basics and Applications, 1st edition, published by Taisei Co.”, or “The Filler Handbook, published by Taisei Co.”.

The filler may be conventional inorganic fillers or pigments; specific examples thereof include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among these, silica and alumina are preferable. These may be used alone or in combination. It is preferred that the filler has a small particle diameter, since larger particle diameters tend to roughen the surface of toner image-receiving layers.

The silica described above may be spherical or amorphous. The silica may be produced by dry, wet, or aero-gel processes. Hydrophobic silica particles may be surface-treated with trimethylsilyl group or silicones as required. The silica is preferably colloidal silica and/or porous.

The alumina described above may be anhydrous or hydrated one. Examples of the crystallized anhydrous alumina include α, β, γ, δ, ζ, η, θ, κ, ρ, or χ; hydrated alumina is more preferable than anhydrous alumina. Examples of the hydrated alumina include monohydrated alumina and trihydrate alumina. Examples of the monohydrated alumina include pseudo-boehmite, boehmite and diaspore. Examples of the trihydrated alumina include gibbsite and bayerite. The alumina is preferably porous.

The hydrated alumina may be synthesized by sol-gel processes in which ammonia is added to an aluminum-salt solution to precipitate alumina or by hydrolyzing an alkali aluminate. The anhydrous alumina may be produced by heating to dehydrate the hydrated alumina.

The content of the filler is preferably 5 to 2,000 parts by mass based on 100 parts by dry mass of the binder resin in the toner image-receiving layer.

The crosslinking agent may be incorporated in the resin composition of the toner image-receiving layer for controlling the shelf stability and thermoplasticity of the toner image-receiving layer. The crosslinking agent are exemplified by compounds having in the molecule two or more reactive groups selected from the group consisting of epoxy group, isocyanate group, aldehyde group, active halogen group, active methylene group, acetylene group and other conventional reactive groups.

The crosslinking agent may also be exemplified by compounds having in the molecule two or more groups which can form a bond through a hydrogen bond, an ionic bond or a coordination bond.

Specific examples of the crosslinking agent include conventional compounds as coupling agents, curing agents, polymerizing agents, polymerization promoters, coagulants, film-forming agents, or film-forming assistants used for conventional resins. Examples of the coupling agent include chlorosilanes, vinylsilanes, epoxisilanes, aminosilanes, alkoxy aluminum chelates, titanate coupling agents, and other conventional crosslinking agents described in the literature “Handbook of Rubber and Plastics Additives” (edited by Rubber Digest Co.).

The toner image-receiving layer preferably contains a charge control agent for controlling the transfer and adhesion of the toner and for preventing the adhesion of the toner image-receiving layer due to the charge.

The charge control agent may be properly selected from various conventional ones depending on the application; examples thereof include surfactants such as cationic surfactants, anionic surfactants, amphoteric surfactants, and non-ionic surfactants; polymer electrolytes, and conductive metal oxides. Specific examples of the charge control agent include cationic antistatic agents such as quaternary ammonium salts, polyamine derivatives, cation-modified polymethyl methacrylates, cation-modified polystyrenes; anionic antistatic agents such as alkyl phosphates and anionic polymers; and non-ionic antistatic agents such as fatty esters, and polyethylene oxides.

When the toner is negatively charged, the charge control agent in the toner image-receiving layer is preferably a cationic or nonionic charge control agent.

Examples of the conductive metal oxide include ZnO, TiO₂, SnO₂, Al₂O₃, In₂O₃, SiO₂, MgO, BaO and MoO₃. These may be used alone or in combination. The conductive metal oxide may contain or dope another different element, for example, ZnO may contain or dope Al or In; TiO₂ may contain Nb or Ta; and SnO₂ may contain Sb, Nb or halogen elements.

### Other Additives

The toner image-receiving layer may also contain various additives for improving the stability of the output image or the stability of the toner image-receiving layer itself. Examples of the additives include various conventional antioxidants, anti-aging agents, deterioration inhibitors, ozone-deterioration inhibitors, ultraviolet ray absorbers, metal complexes, light stabilizers, antiseptic agents and anti-fungus agents.

The antioxidant may be properly selected depending on the application; examples thereof include chroman compounds, coumarin compounds; phenol compounds such as hindered phenol; hydroquinone derivatives, hindered amine derivatives, and spiroindane compounds. The antioxidant is also disclosed in JP-A No. 61-159644.

The anti-aging agent may be properly selected depending on the application; examples thereof include those described in “Handbook of Rubber and Plastics Additives, 2nd edition, published by Rubber Digest Co., 1993, pp. 76-121”.

The ultraviolet ray absorber may be properly selected depending on the application; examples thereof include benzotriazol compounds (see U.S. Pat. No. 3,533,794), 4-thiazolidone compounds (see U.S. Pat. No. 3,352,681), benzophenone compounds (see JP-A No. 46-2784), and ultraviolet ray absorbing polymers (see JP-A No. 62-260152).

The metal complex may be properly selected depending on the application; proper examples thereof are described in U.S. Pat. Nos. 4,241,155, 4,245,018, and 4,254,195; and JP-A Nos. 61-88256, 62-174741, 63-199248, 01-75568 and 01-74272.

In addition, ultraviolet ray absorbers or light stabilizers may be those described in “Handbook on Compounding Ingredients for Rubbers and Plastics, revised second edition” (published by Rubber Digest Co., 1993, pp. 122-137).

The toner image-receiving layer may optionally contain the above-noted conventional photographic additives. Examples of the photographic additives include those described in “Journal of Research Disclosure (hereinafter referred to as RD) No. 17643 (December, 1978), No. 18716 (November, 1979) and No. 307105 (November, 1989)”; the related portions are shown in the Table 1 below.

TABLE 1

| Additive | RD17643 | RD18716 | RD307105 |
|---|---|---|---|
| Whitening agent | p. 24 | p. 648 right column | p. 868 |
| Stabilizer | pp. 24-25 | p. 649 right column | pp. 868-870 |
| Light (UV) absorber | pp. 25-26 | p. 649 right column | p. 873 |
| Dye image stabilizer | p. 25 | p. 650 right column | p. 872 |
| Film hardener | p. 26 | p. 651 left column | pp. 874-875 |
| Binder | p. 26 | p. 651 left column | pp. 873-874 |
| Plasticizer, lubricant | p. 27 | p. 650 right column | p. 876 |
| Auxiliary coating agent | pp. 26-27 | p. 650 right column | pp. 875-876 |
| Antistatic agent | p. 27 | p. 650 right column | pp. 876-877 |
| Matting agent | — | — | pp. 878-879 |

The toner image-receiving layer is disposed on the support by coating the support with the coating solution containing a thermoplastic resin used for producing the toner image-receiving layer using a wire coater and by drying the resultant coating. The film-forming temperature of the thermoplastic resin is preferably no less than room temperature for preservation before the printing, and no higher than 100° C. for fixing toner particles.

The mass of the dried coating as the toner image-receiving layer is preferably 1 to 20 g/m², more preferably 4 to 15 g/m².

The thickness of the toner image-receiving layer may be properly selected depending on the application; preferably, the thickness is no less than half of the toner particle diameter, more preferably, one to three times of the diameter; specifically, the thickness is preferably 1 μm to 50 μm, more preferably 1 μm to 30 μm, still more preferably 2 μm to 20 μm, most preferably from 5 μm to 15 μm.

### Properties of Toner Image-Receiving Layer

The 180 degree peel strength of the toner image-receiving layer, at the fixing temperature with a fixing member, is preferably 0.1 N/25 mm or less, more preferably 0.041 N/25 mm or less. The 180 degree peel strength can be measured in accordance with JIS K 6887 using the surface material of the fixing member.

It is preferred that the toner image-receiving layer has a high whiteness. The whiteness, which may be measured by the method described in JIS P 8123, is preferably 85% or more. It is preferred that the spectral reflectance of the toner image-receiving layer is 85% or more in the wavelength range of 440 nm to 640 nm and the difference is 5% or less between the maximum spectral reflectance and minimum spectral reflectance of the toner image-receiving layer in the above-noted wavelength range. It is also preferred that the spectral reflectance of the toner image-receiving layer is 85% or more in the wavelength range of 400 to 700 nm and the difference is 5% or less between the maximum spectral reflectance and minimum spectral reflectance of the toner image-receiving layer in the above-noted wavelength range.

With respect to the whiteness of the toner image-receiving layer, specifically in the CIE 1976 (L* a* b*) color space, L* value is preferably 80 or more, more preferably 85 or more, still more preferably 90 or more. The tone of the whiteness is preferably as neutral as possible and more specifically, with respect to the tone of the whiteness of the toner image-receiving layer in the (L* a* b*) space, the value of (a*)²+(b*)² is preferably 50 or less, more preferably 18 or less, still more preferably 5 or less.

It is preferred that the toner image-receiving layer has a high glossiness after image formation. The 45° glossiness of the toner image-receiving layer is preferably 60 or more, more preferably 75 or more, still more preferably 90 or more over the entire region from white with no toner to black with the highest toner concentration. The glossiness of the toner image-receiving layer is preferably 110 or less, since the glossiness above 110 may resemble a metal gloss unfavorable for image quality. The gloss level can be measured according to JIS Z 8741.

It is preferred that the toner image-receiving layer has a high smoothness after fixing images. The smoothness of the toner image-receiving layer is preferably 3 μm or less, more preferably 1 μm or less, still more preferably 0.5 μm or less with respect to arithmetic average surface roughness Ra over the entire region from white with no toner to black with the highest toner concentration.

The arithmetic average surface roughness may be measured according to JIS B 0601, JIS B 0651 and JIS B 0652.

The toner image-receiving layer has preferably at least one of the physical properties described in the following items (1) to (6), more preferably several of them, most preferably all of them.

(1) It is preferred that the melting temperature (Tm) of the toner image-receiving layer is 30° C. or higher and no higher than Tm of the toner+20° C.

(2) It is preferred that the temperature, at which the viscosity of the toner image-receiving layer being 1×10⁵ cp, is 40° C. or higher and lower than that of the toner.

(3) It is preferred that the storage elasticity modulus (G′) of the toner image-receiving layer is from 1×10² Pa to 1×10⁵ Pa and the loss elasticity modulus (G″) is preferably from 1×10² Pa to 1×10⁵ Pa at the fixing temperature.

(4) It is preferred that the loss tangent (G″/G′) of the toner image-receiving layer at the fixing temperature is from 0.01 to 10, wherein the loss tangent is the ratio of the loss elasticity modulus (G″) to the storage elasticity modulus (G′).

(5) It is preferred that the storage elasticity modulus (G′) of the toner image-receiving layer at the fixing temperature differs by −50 to +2500 from the storage elasticity modulus (G′) of the toner at the fixing temperature.

(6) The inclination angle of the molten toner on the toner image-receiving layer is preferably 50° or less, more preferably 40° or less.

The toner image-receiving layer preferably satisfies the physical properties described in Japanese Patent No. 2788358 and JP-A Nos. 07-248637, 08-305067 and 10-239889.

The surface electrical resistance of the toner image-receiving layer is preferably in the range of 1×10⁶ Ω/cm² to 1×10¹⁵ Ω/cm² (under a condition of 25° C. and 65% RH).

When the surface electrical resistance is less than 1×10⁶ Ω/cm², the amount of the toner transferred to the toner image-receiving layer is insufficient such that the density of the toner images is unfavorably low, and when the surface electrical resistance is more than 1×10¹⁵ Ω/cm², unnecessary charge tends to generate in the toner image-receiving layer during the transfer, thus the toner is insufficiently transferred, the image density is low, and electrophotographic materials tend to be electrostatically charged to adsorb easily the ambient dusts. Moreover, miss feed, overlapping feed, discharge marks, and toner-transfer voids may occur during the copying processes.

The surface electrical resistance can be measured according to JIS K 6911 as follows: the sample of the toner image-receiving layer is conditioned under temperature 20° C. and humidity 65% for 8 hours or more, and after applying a voltage of 100 V to the sample of the toner image-receiving layer for 1 minute under the same condition as the above-noted condition using a micro-ammeter R8340 (by Advantest Ltd.).

### Other Layers

The other layers in the electrophotographic material are exemplified by a back layer, surface-protecting layer, adhesion-improving layer, intermediate layer, undercoat layer, cushion layer, charge-control layer, reflective layer, tint-control layer, shelf stability-improving layer, anti-adhesion layer, anti-curling layer and smoothing layer. These layers may be formed of one or more layers.

### Surface Protective Layer

The surface protective layer may be disposed on the surface of the toner image-receiving layer for protecting the surface of the electrophotographic material, improving shelf stability, handling properties and transportability, and imparting writing properties and anti-offset properties thereto. The surface protective layer may be of mono-layer or multi-layer. The surface protective layer may contain as a binder resin at least one of various thermoplastic resins and thermosetting resins, which is preferably of the same type as that of the resin used for the toner image-receiving layer. In this case, the resin used for the surface protective layer is not required to have the same thermodynamic properties or electrostatic properties as those of the resin used for the toner image-receiving layer, i.e. those properties may be independently optimized.

The surface protective layer may contain the above-noted various additives for the toner image-receiving layer. Particularly, the surface protective layer may contain other additives such as a matting agent together with the above-noted releasing agent used in the present invention. Examples of the matting agent include various conventional ones.

The outermost surface layer of the electrophotographic material (e.g. the surface protective layer when disposed) has preferably adequate compatibility with the toner from the viewpoint of good fixability of the toner image. More specifically, the outermost surface layer has preferably a contact angle of 0° to 40° with the molten toner.

### Back Layer

In the electrophotographic material, the back layer may be disposed at the side of the support opposite to the toner image-receiving layer for the purpose of improving back side-output suitability, image quality of the back side-output, curling balance and transportability.

The color of the back layer may be properly selected depending on the application; when the electrophotographic material is used to form images on both sides, the color of the back layer is preferably white. The whiteness and the spectral reflectance of the back layer are preferably 85% or more similarly as that of the front side.

In view of both-side output suitability, the back layer may have the same constitution as that of the toner image-receiving layer. The back layer may contain various additives described with respect to the toner image-receiving layer; preferably, a matting agent and a charge control agent are compounded. The back layer may be of mono-layer or multi-layer.

When a releasing oil is applied to fixing rollers for preventing offset during the image fixing, the back layer may have oil absorbency. The thickness of the back layer is preferably 0.1 μm to 10 μm.

### Adhesion-Improving Layer

The adhesion-improving layer in the electrophotographic material is preferably disposed for improving adhesion between the support and the toner image-receiving layer. The adhesion-improving layer may contain the above-noted various additives, particularly preferably the crosslinker. It is also preferred for the electrophotographic material that, in view of improving the toner receptivity, a cushion layer is disposed between the adhesion improving layer and the image-receiving layer.

### Intermediate Layer

The intermediate layer may be disposed, for example, between the support and the adhesion-improving layer, between the adhesion-improving layer and the cushion layer, between the cushion layer and the toner image-receiving layer, or between the toner image-receiving layer and the shelf stability improving layer. When the electrophotographic material contains the support, the toner image-receiving layer, and the intermediate layer, the intermediate layer may be disposed, for example, between the support and the toner image-receiving layer.

The thickness of the electrophotographic material may be properly selected depending on the application; the thickness is preferably from 50 μm to 550 μm, and more preferably from 100 μm to 350 μm.

### Toner

The inventive electrophotographic material is used in a manner that the toner image-receiving layer receives a toner during printing or copying processes. The toner comprises at least a binder resin and a colorant, and optionally a releasing agent and other components.

### Binder Resin for Toner

The binder resin may be properly selected from those conventionally used for producing toners depending on the application. Examples of the binder resin include homo-polymers or copolymers of vinyl monomers such as styrene and parachlorostyrene; vinyl esters such as vinyl naphthalene, vinyl chloride, vinyl bromide, vinyl fluoride, vinyl acetate, vinyl propionate, vinyl benzoate and vinyl butyrate; methylene fatty carboxylate esters such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; vinyl nitriles such as acrylonitrile, methacrylonitrile and acrylamide; vinyl ethers such as vinyl methyl ether, vinyl ethyl ether and vinyl isobutyl ether; N-vinyl compounds such as N-vinyl pyrrole, N-vinyl carbazole, N-vinyl indole and N-vinyl pyrrolidone; and vinyl carboxylic acids such as methacrylic acid, acrylic acid and cinnamic acid, and also various polyesters. These binder resins may be used in combination with various waxes.

Among these resins, the same type as that of the toner image-receiving layer is preferably used.

### Colorant for Toner

The colorant may be properly selected from those conventionally used for producing toners depending on the application. Examples of the colorant include various pigments such as carbon black, chrome yellow, hansa yellow, benzidine yellow, threne yellow, quinoline yellow, Permanent Orange GTR, Pyrazolone orange, vulcan orange, watchung red, permanent red, Brilliant Carmine 3B, Brilliant Carmine 6B, Du Pont Oil Red, Pyrazolone Red, Lithol Red, Rhodamine B lake, Lake Red C, Rose Bengal, aniline blue, ultra marine blue, chalco oil blue, methylene blue chloride, phthalocyanine blue, phthalocyanine green, malachite green oxalate; and various dyes such as acridine dyes, xanthene dyes, azo dyes, benzoquinone dyes, azine dyes, anthraquinone dyes, indigo dyes, thioindigo dyes, dioxazine dyes, thiazine dyes, azomethine dyes, phthalocyanine dyes, aniline black dyes, polymethine dyes, triphenylmethane dyes, diphenylmethane dyes, and thiazole dyes. These colorants may be used alone or in combination of two or more.

The content of the colorant may be properly selected depending on the application. The content is preferably from 2 to 8% by mass, based on the mass of the toner. The colorant content less than 2% by mass may be lack in tinting strength, and the content more than 8% by mass may impair the toner clarity.

### Releasing Agent for Toner

The releasing agent may be properly selected from ones conventionally used for toners; particularly preferable are high-crystalline polyethylene waxes with lower molecular masses, Fischer-Tropsch wax, amide waxes and nitrogen-containing polar waxes such as compounds having a urethane bond. Preferably, the polyethylene wax has a molecular mass of 1000 or less, more preferably from 300 to 1000.

Compounds having a urethane bond are advantageous since the compounds may maintain a solid state due to a strong cohesive force derived from the polar group and have a high melting point regardless of the lower molecular masses. The compounds preferably have a molecular mass of 300 to 1000. The raw materials for producing the compounds having a urethane bond are exemplified by combinations of a diisocyanic acid and a monohydric alcohol, a monoisocyanic acid and a monohydric alcohol, a dihydric alcohol and a monoisocyanic acid, a trihydric alcohol and a monoisocyanic acid, and a triisocyanic acid and a monohydric alcohol. In order to prevent the excessively large molecular mass, combination of compounds having a multiple functional group and compounds having a single functional group are preferable, and it is important that their functionalities are equivalent.

Examples of the monoisocyanic acid include dodecyl isocyanate, phenyl isocyanate and derivatives thereof, naphthyl isocyanate, hexyl isocyanate, benzyl isocyanate, butyl isocyanate and allyl isocyanate.

Examples of the diisocyanic acid include tolylene diisocyanate, 4,4′-diphenylmethane diisocyanate, toluene diisocyanate, 1,3-phenylene diisocyanate, hexamethylene diisocyanate, 4-methyl-m-phenylene diisocyanate and isophorone diisocyanate.

Examples of the monohydric alcohol include methanol, ethanol, propanol, butanol, pentanol, hexanol and heptanol.

Examples of the dihydric alcohol include various glycols such as ethylene glycol, diethylene glycol, triethylene glycol and trimethylene glycol; examples of the trihydric alcohol include trimethylol propane, triethylol propane and trimethanol ethane.

These urethane compounds may be mixed with a resin or a colorant during kneading processes similarly as conventional releasing agents. In cases used with toners that are produced through emulsion polymerization, coagulation and melting processes, these urethane compounds may be used in such a manner as dispersing into water with an ionic surfactant or a polymer electrolyte like polymeric acids and polymeric bases, heating above its melting point, micronizing under a strong shear force by use of a homogenizer or a pressure-discharging dispersing device, thereby to prepare a releasing agent dispersion having a particle size of 1 μm or less, then the dispersion is used with a dispersion of resin particles and/or colorant dispersion.

### Other Components of Toner

The toner may contain other components such as an inner additive, a charge control agent and inorganic fine particles. Examples of the inner additive include magnetic materials like metals such as ferrite, magnetite, reduced iron, cobalt, nickel and manganese, alloys thereof, and compounds containing these metals.

Examples of the charge control agent include conventional charge control agents such as quaternary ammonium salts, nigrosine compounds, dyes containing a metal complex of such as of aluminum, iron and chromium and triphenylmethane pigments. It is preferred that the charge control agent is hardly water-soluble from the view point of controlling ion strength possibly affecting the stability of during the coagulation and the melting and reducing the waste water pollution.

Examples of the inorganic fine particles may be conventional external additives as regarding the toner surface, such as silica, alumina, titania, calcium carbonate, magnesium carbonate and tricalcium phosphate, which are preferably used in a form of dispersion by dispersing the particles with an ionic surfactant, polymer acid or polymer base.

Further, the toner may contain a surfactant with an aim of emulsion polymerization, seed emulsion polymerization, pigment dispersion, resin particle dispersion, releasing agent dispersion, cohesion and stabilization thereof. Examples of the surfactant include anionic surfactants such as sulfate esters, sulfonate esters, phosphate esters and soaps; cationic surfactants such as amine salts and quaternary ammonium salts. These surfactants may be effectively combined with nonionic surfactants such as polyethylene glycol, alkylphenol ethylene oxide adducts and polyhydric alcohols. The device for dispersing the surfactant in the toner may be conventional ones such as rotary shearing homogenizers, ball mills, sand mills and dyno mills.

The toner may contain optionally another external additive, which may be inorganic or organic particles. Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄ and MgSO₄. Examples of the organic particles include fatty acids and derivatives thereof; metal salts of the fatty acid and derivatives thereof; and resins such as fluorine resins, polyethylene resins and acrylic resins. The average particle diameter of these particles is preferably from 0.01 μm to 5 μm, more preferably from 0.1 μm to 2 μm.

The method for producing the toner may be properly selected depending on the application; preferably, the method include (i) preparing a cohesive particle dispersion by forming cohesive particles in a resin particle dispersion, (ii) producing attached particles by mixing the cohesive particle dispersion with a fine particle dispersion so that the fine particles attach to the cohesive particles and (iii) producing toner particles by heating and melting the attached particles.

### Toner Properties

It is preferable that the toner has a volume average particle diameter of 0.5 μm to 10 μm. When the volume average particle diameter of the toner is excessively small, toner processability such as supplying ability, cleaning ability and flowability may be poor and the particle productivity may be lowered. In contrast, when the volume average particle diameter of the toner is excessively large, the quality and resolution of images may be affected adversely due to graininess and transferability.

It is preferred that the toner in the present invention satisfies the range of the volume average particle diameter described above and has a distribution index of the volume average particle diameter (GSDv) of 1.3 or less.

The ratio (GSDv/GSDn) of the distribution index of the volume average particle diameter (GSDv) to the distribution index of the number average particle diameter (GSDn) is preferably 0.95 or more.

It is also preferred that the toner in the present invention satisfies the above-noted range of the volume average particle diameter and has an average of 1.00 to 1.50 in terms of the shape factor calculated from the following equation:

Shape factor=(π×L²)/(4×S)

wherein L represents the maximum length of toner particles and S represents the projected area of toner particles.

When the toner satisfies the above-noted relation, image quality such as graininess and resolution may be improved, dropout or blur during transferring steps may be suppressed, and handling properties of the toner may be less adversely affected regardless out of smaller average particle diameters.

From the viewpoint of improving the image quality and preventing the offset during the fixing step, it is preferred that the toner has a storage elastic modulus G′ of 1×10² Pa to 1×10⁵ Pa at 150° C. as measured at an angular frequency of 10 rad/sec.

### Heat-Sensitive Material

The heat sensitive material has at least a heat-sensitive recording layer as the image recording layer on the inventive support for image recording material, for example, and may be used in Thermo-Autochrome (TA) processes, in which images are formed through repeatedly heating by heat-sensitive heads and fixing by UV rays.

### Sublimation Transfer Material

The sublimation transfer material has an ink layer containing a heat-diffusion pigment (subliming pigment) on the inventive support for image-recording material support, for example, and used for sublimation transfer processes, in which the heat-diffusion pigment is transferred from the ink layer to a sublimation transfer sheet through heating by heat-sensitive heads.

### Heat Transfer Material

The heat transfer material has at least a heat-melting ink layer as the image-recording layer on the support for image recording material, for example, and used for melting transferring processes, in which a heat-sensitive head heats the heat-melting ink layer thereby to melt and transfer the ink to a heat transfer sheet.

### Heat Development Material

The heat development material is exemplified by those having a construction that a photosensitive heat-sensitive recording layer, e.g. described in JP-A No. 2002-40643, as the image recording layer is disposed on the inventive support for image recording material, and visible images may be formed through heating the exposed heat development material by use of a heating device such as heating rollers, heating belts, plate heaters, thermal heads, laser lights, and combinations thereof.

In addition, the heat development material is exemplified by those having a construction that a heat-development photosensitive recording layer, e.g. described in JP-A No. 2004-246026, as the image recording layer is disposed on the inventive support for image recording material, and visible images may be formed through heating the exposed heat development material by use of a heating device such as heating rollers, heating belts, plate heaters, thermal heads, laser lights, and combinations thereof.

### Silver Salt Photographic Material

The silver salt photographic material is exemplified by those having a construction that at least an image-recording layer, which develops at least yellow (Y), magenta (M), or cyan (C), as the above-noted image recording layer, is disposed on the inventive support of image recording material, and used for silver halide photography, in which the exposed silver halide photographic sheet is soaked into several treatment-baths so as to color-develop, bleach and fix, and then rinse and dry.

### Ink-Jet Recording Material

The ink-jet recording material has, on the inventive support of image recording material, the above-noted image recording layer of an ink-receiving layer, in which the ink may be a liquid ink such as aqueous inks and oily inks (colorant being dyes or pigments) or a solid ink that is solid at room temperature and applied for images upon melting and fluidizing.

### Printing Paper

The inventive support for image recording material may be advantageously used as printing paper. In order to be used as printing paper, it has preferably higher mechanical strength since inks are applied by printing machines.

The printing paper may be advantageously used as offset printing paper, and also letterpress printing paper, gravure printing paper, and electrophotographic paper.

The inventive image recording material comprises the support for image recording material, which being free from occurrences of uneven recording or uneven fixing, and the image recording layer on the support, thus can record high-quality images, and advantageously used as electrophotographic material, heat-sensitive material, sublimation transfer material, heat transfer material, heat development material, silver salt photographic material and ink-jet recording material.

### Image Recording Method

The inventive image recording method, in the first embodiment, comprises an image recording step to record images through heating a heat-sensitive recording material that has at least a heat-sensitive recording layer on the inventive support for image recording material by use of thermal heads and laser lights, and optionally other steps as required.

The image recording step may be properly selected from conventional steps as long as such a heat-sensitive recording material is utilized that has at least a heat-sensitive recording layer on the inventive support for image recording material.

The thermal head may be properly selected from conventional ones; preferable examples are thermal heads of area-type, in which plural heating elements being vertically and horizontally aligned and disposed in a pre-determined area, and thermal heads of line type, in which plural heating elements being disposed vertically.

The laser may be properly selected from conventional ones depending on the application; the laser light may be gas laser lights such as argon ion laser light, helium neon laser light and helium cadmium laser light; solid laser lights such as YAG laser light; semiconductor laser light, dye laser light, and direct laser light such as excimer laser light.

The heating temperature may be properly selected depending on the application.

The inventive image recording method, in the second embodiment, comprises a latent image-recording step, a heat development step, and optionally other steps as required. In the latent image-recording step, a heat transfer material, having a image recording layer (e.g. photosensitive heat-sensitive recording layer, heat-development photosensitive layer) on the inventive support for image recording material, is exposed to form a latent image.

In the heat development step, the exposed heat-development material is heated by use of a heating device such as heating rollers, heating belts, plate heaters, thermal heads, laser lights, and combinations thereof to form a visible image.

The heating temperature may be properly selected depending on the application; preferably, the heating temperature is 80° C. to 250° C.

The inventive image recording method, in the third embodiment, comprises a toner image-forming step, a heat fixing step, and optionally other steps as required.

In the toner image-forming step, a toner image is formed on an electrophotographic material that has at least a toner image-receiving layer on the inventive support for image recording material.

The toner image-forming step may be properly selected depending on the application as long as capable of forming images on an electrophotographic material; for example, the toner image-forming step may be on the basis of usual electrophotographic processes such as direct transfer processes where a toner image on a development roller is transferred on an electrophotographic material or intermediate transfer belt processes where a toner image is primarily transferred on an intermediate transfer belt and then transferred on an electrophotographic material. Among these, intermediate transfer belt processes are preferable in view of environmental stability and high image quality.

In the heat fixing step, toner images formed in the toner image-forming step are fixed through heating by use of fixing rollers, fixing belts, and combinations thereof. The heating temperature may be properly selected depending on the application; preferably, the heating temperature is 80° C. to 200° C.

The inventive image recording method, in the forth embodiment, comprises a toner image-forming step, an image-surface smoothing-fixing step, and optionally other steps as required.

The toner image-forming step is substantially the same as that of the third embodiment.

In the image-surface smoothing-fixing step, the toner image surface is smoothed after the toner image-forming step; more specifically, toner images are heated, pressed, cooled and peeled using a device configured to fix the toner image and to smooth the toner image surface, which is equipped with a heating-pressurizing unit, a belt, and a cooling unit, in the image-surface smoothing-fixing step.

The heating-pressurizing unit may be properly selected depending on the application and exemplified by a pair of heat rollers or combinations of heat rollers and pressurizing rollers. The cooling unit may be properly selected depending on the application and exemplified by cooling units that blow a cool air and control the cooling temperature, and heat sinks.

The cooling-peeling site may be properly selected depending on the application and exemplified by a section near a tension roller where the electrophotographic material is peeled from a belt by virtue of its stiffness or nerve.

The image-receiving sheet is preferably pressurized, when contacting the toner image with a heating-pressurizing unit of the device configured to fix the image and to smooth the image surface. The method for pressurizing the image-receiving sheet may be properly selected depending on the application; preferably, a nip pressure is employed. The nip pressure is preferably 1 to 100 kgf/cm² (9.8 to 980 N/cm²), more preferably 5 to 30 kgf/cm² (49 to 294 N/cm²) from the viewpoint of forming images with excellent water resistance, surface smoothness and high gloss. The heating temperature in the heating-pressurizing unit is no lower than the softening point of the polymer in the toner image-receiving layer and typically depends on the polymer in the toner image-receiving layer; preferably, the temperature is 80° C. to 200° C. The cooling temperature in the cooling unit is preferably no higher than 80° C. at which the toner image-receiving being solidified, more preferably from 20° C. to 80° C.

The belt contains a heat-resistant support film and a releasing layer disposed on the support film.

The material for the support film may be suitably selected depending on the application from those of heat resistant; examples thereof include polyimide (PI), polyethylene naphthalate (PEN), polyethylene terephthalate (PET), polyether ether ketone (PEEK), polyether sulfone (PES), polyether imide (PEI) and polyparabanic acid (PPA).

The releasing layer preferably contains at least one selected from the group consisting of silicone rubbers, fluorine rubbers, fluorocarbon siloxane rubbers, silicone resins and fluorine resins. Preferably, a fluorocarbon siloxane rubber-containing layer is disposed on the surface of the belt support; or a silicone rubber-containing layer is disposed on the surface of the belt and a fluorocarbon siloxane rubber-containing layer is further disposed on the surface of the silicone rubber-containing layer.

The fluorocarbon siloxane rubber in the fluorocarbon siloxane rubber-containing layer has preferably in the main chain thereof at least one of perfluoroalkyl ether groups and perfluoroalkyl groups.

The fluorocarbon siloxane rubber is preferably a cured product of a fluorocarbon siloxane rubber composition containing the following components (A) to (D).

(A) fluorocarbon polymer containing mainly a fluorocarbon siloxane represented by the following General Formula (1) and having an unsaturated fatty hydrocarbon group,

(B) at least one of organopolysiloxane and fluorocarbon siloxane which have two or more ≡SiH groups in the molecule, wherein the amount of a ≡SiH group is from one to four times by mole the amount of the unsaturated fatty hydrocarbon group in the above-noted fluorocarbon siloxane rubber composition,

(C) filler, and

(D) effective amount of catalyst.

The fluorocarbon polymer as the component (A) contains mainly a fluorocarbon siloxane containing a recurring unit represented by the following General Formula (1) and contains an unsaturated fatty hydrocarbon group.

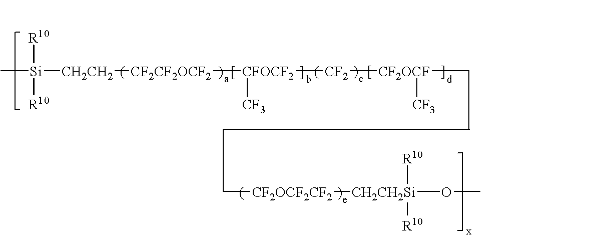

In General Formula (1), R¹⁰ represents an unsubstituted or substituted monovalent hydrocarbon group having 1 to 8 carbon atoms and is preferably an alkyl group having 1 to 8 carbon atoms or a alkenyl group having 2 to 3 carbon atoms, most preferably a methyl group; “a” and “e” are each an integer of 0 or 1, “b” and “d” are each an integer of 1 to 4 and “c” is an integer of 0 to 8; and “x” is preferably an integer of 1 or more, more preferably an integer of 10 to 30.

Examples of the component (A) include a compound represented by the following General Formula (2):

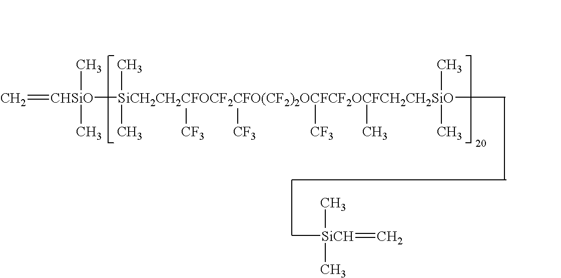

With respect to the component (B), examples of the organopolysiloxane having ≡SiH groups include organohydrogen polysiloxanes having in the molecule at least two hydrogen atoms bonded to a silicon atom.

In the fluorocarbon siloxane rubber composition, when the fluorocarbon polymer as the component (A) has an unsaturated fatty hydrocarbon group, as a curing agent, the above-noted organohydrogen polysiloxane is preferably used. In other words, the cured form is produced by an addition reaction between the unsaturated fatty hydrocarbon group of the fluorocarbon siloxane and a hydrogen atom bonded to a silicon atom in the organohydrogen polysiloxane.

Examples of the organohydrogen polysiloxane include various organohydrogen polysiloxanes used for curing a silicone rubber composition which is cured by an addition reaction.

The amount of the organohydrogen polysiloxane is preferably such that the number of ≡SiH groups is at least one, more preferably from 1 to 5 relative to one unsaturated fatty hydrocarbon group in the fluorocarbon siloxane of the component (A).

With respect to the component (B), preferable examples of the fluorocarbon siloxane having the ≡SiH groups are fluorocarbon siloxanes having a structure of the recurring unit represented by the General Formula (1), and fluorocarbon siloxanes having a structure of the recurring unit represented by the General Formula (1) in which R¹⁰ is a dialkylhydrogen siloxy group and the terminal group is a ≡SiH group, such as a dialkylhydrogen siloxy group or a silyl group. Such a preferable fluorocarbon siloxane may be represented by the following General Formula (3).

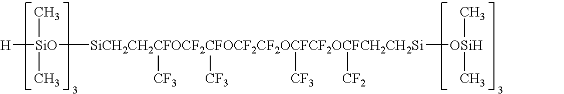

Various fillers for conventional silicone rubber compositions may be used for the filler in the component (C); examples of the filler include aerosol silica, precipitated silica, carbon powder, titanium dioxide, aluminum oxide, quartz powder, talc, sericite and bentonite; and fiber fillers such as asbesto, glass fibers and organic fibers.

The catalyst for the component (D) are exemplified by conventional ones for addition reaction like VIII group elements in Periodic Table and compounds thereof; specific examples thereof include chloroplatinic acid, alcohol-modified chloroplatinic acid, complexes of chloroplatinic acid with olefins; platinum black or palladium supported on carriers such as alumina, silica and carbon; complexes of rhodium with olefins; chlorotris(triphenylphosphine)rhodium (Wilkinson catalyst) and rhodium (III) acetyl acetonate. It is preferred that these complexes are dissolved in a solvent such alcohols, ethers and hydrocarbons.

The fluorocarbon siloxane rubber composition may be properly selected depending on the application, and optionally may contain various additives. Examples of the additives include dispersing agents such as a diphenylsilane diol, lower molecular mass dimethylpolysiloxanes with an end-blocked hydroxyl group, and hexamethyldisilazane; heat resistance improver such as ferrous oxide, ferric oxide, cerium oxide and iron octylate; and colorants such as pigments.

The belt may be produced by coating the surface of a heat-resistant support film with the fluorocarbon siloxane rubber composition and curing and heating the surface of the resultant coated support film. Optionally, the belt may be produced by coating the surface of the support film with a coating solution prepared by diluting the fluorocarbon siloxane rubber composition with a solvent such as m-xylene hexafluoride and benzotrifluoride according to conventional coating processes such as spray coating, dip coating and knife coating. The heating-curing temperature and time may be properly selected from the from 100° C. to 500° C. and from 5 seconds to 5 hours depending on the type of the support film and the production process of the belt.

The thickness of the releasing layer disposed on the surface of the heat-resistant support film may be properly selected depending on the application; the thickness is preferably from 1 μm to 200 μm, more preferably from 5 μm to 150 μm in view of appropriate image fixability while maintaining toner release properties and preventing toner offset.

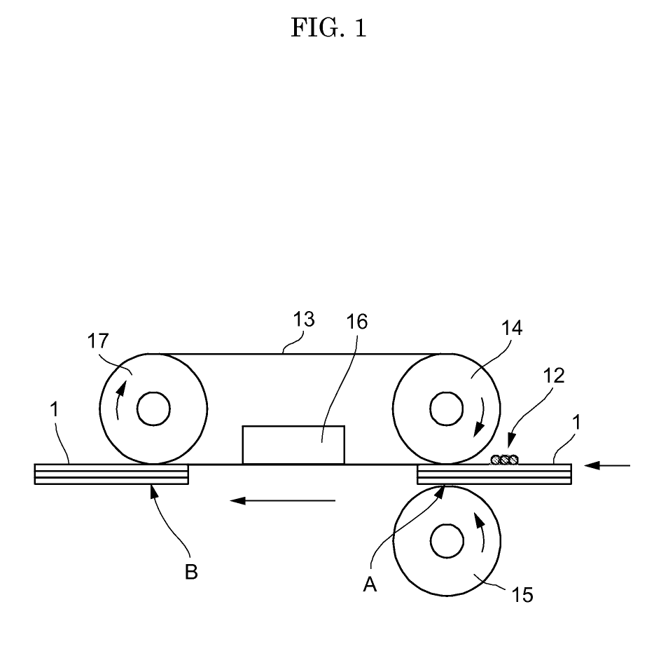

A device to fix images and to smooth the surface thereof available in the inventive image forming apparatus will be exemplarily explained in the following with reference to FIG. 1.

A toner 12 is initially transferred to an electrophotographic material 1 in an image forming apparatus (not shown). The electrophotographic material 1, on which the toner 12 being disposed, is conveyed to the point A by a conveying unit (not shown) and passes through between a heat roller 14 and a pressurizing roller 15 at the fixing temperature a pressure, wherein the temperature and pressure are enough high to soften the toner image-receiving layer of the electrophotographic material 1 or the toner 12.

The fixing temperature refers to that of the surface of the toner image-receiving layer at a nip space of point A between the heat roller 14 and the pressurizing roller 16; the fixing temperature is preferably from 80° C. to 190° C., more preferably from 100° C. to 170° C. The fixing pressure refers to that on the surface of the toner image-receiving layer also at a nip space of point A between the heat roller 14 and the pressurizing roller 16; the fixing pressure is preferably from 1 to 10 kgf/cm² (9.8 to 98 N/cm²), more preferably from 2 to 7 kgf/cm² (19.6 to 68.6 N/cm²).

The heated and pressurized electrophotographic material 1 is then conveyed by a fixing belt 13 to a cooling unit 16, meanwhile, a releasing agent (not shown), dispersed in the toner image-receiving layer, is well heated and molten and migrates to the surface of the toner image-receiving layer. The migrating releasing agent forms a layer or film at the surface of the toner image-receiving layer. Then the electrophotographic material 1 is conveyed to the cooling unit 16 by the fixing belt 13 and then cooled by the cooling unit 16 to a temperature, for example, no higher than either the softening point of the binder resin in the toner image-receiving layer or the toner, or to a temperature lower than the glass transition point of the above-noted binder resin plus 10° C., wherein the temperature to which the electrophotographic material 1 is cooled is preferably from 20° C. to 80° C., more preferably room temperature. Thus the layer or film of the releasing agent formed at the surface of the toner image-receiving layer is cooled and solidified, thereby forming the releasing agent layer.

The cooled electrophotographic material 1 is conveyed by the fixing belt 13 further to the point B and the fixing belt 13 moves along the tension roller 17. Accordingly, at the point B, the electrophotographic material 1 is peeled from the fixing belt 13. It is preferred that the diameter of the tension roller 17 is so small designed that the electrophotographic material can be peeled from the fixing belt 13 by own stiffness or nerve.

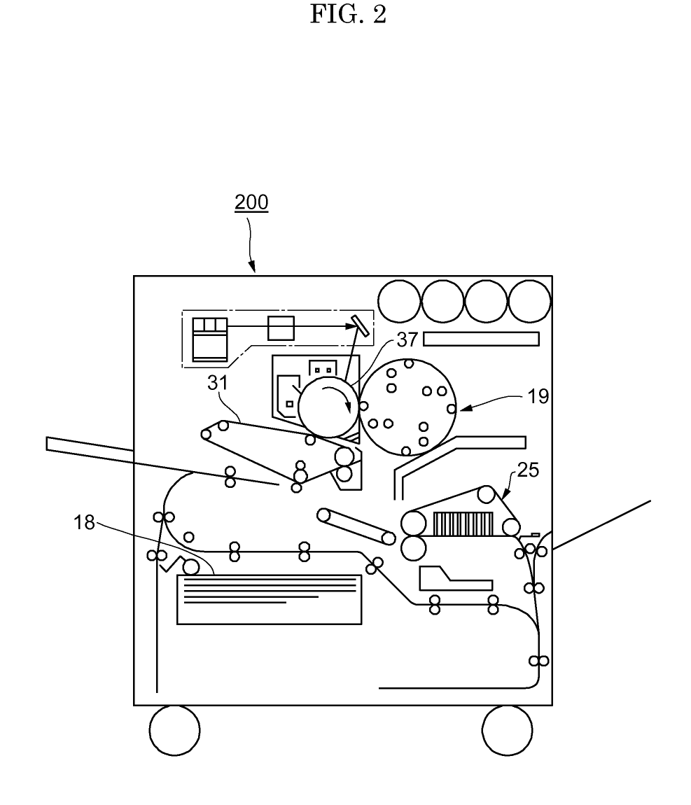

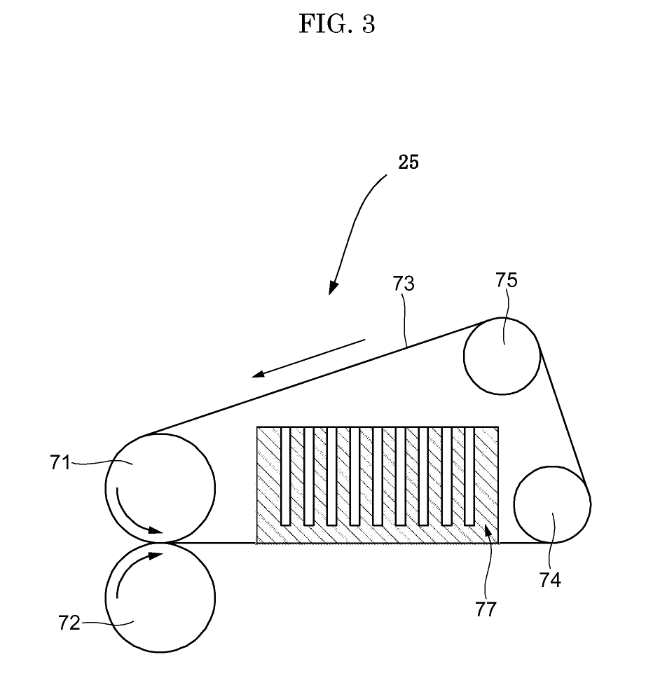

The device configured to fix images and to smooth the image surface shown in FIG. 3 may be modified and used for the image forming apparatus (e.g., full-color laser printer DCC-500, by Fuji Xerox Co.) shown in FIG. 2 by converting the image forming apparatus to a part of the belt fixing in the image forming apparatus.

As shown in FIG. 2, an image forming apparatus 200 is equipped with a photoconductive drum 37, a development device 19, an intermediate transfer belt 31, an electrophotographic material 18, and a fixing unit 25 or a device configured to fix an image and to smooth the image surface.

FIG. 3 shows the device 25 configured to fix images and to smooth the image surface or the fixing unit which is arranged inside the image forming apparatus 200 in FIG. 2.

As shown in FIG. 3, the device 25 configured to fix an image and to smooth the image surface is equipped with a heat roller 71, a peeling roller 74, a tension roller 75, an endless belt 73 supported rotatably by the tension roller 75 and pressurizing roller 72 contacted by pressure to the heat roller 71 through the endless belt 73.

A cooling heatsink 77 that forces the endless belt 73 to cool is arranged inside the endless belt 73 between the heat roller 71 and the peeling roller 74. The cooling heatsink 77 constitutes a cooling and sheet-conveying unit for cooling and conveying the electrophotographic material.

In the device 25 configured to fix an image and to smooth the image surface as shown in FIG. 3, the electrophotographic image-receiving sheer bearing a color toner image transferred and fixed on its surface is introduced into a press-contacting portion (or nip portion) between the heat roller 71 and the pressurizing roller 72 contacted by being urged to the heat roller 71 through the endless belt 73 such that the color toner image in the image-receiving sheet faces to the heat roller 71, thus the color toner image is heated and fused on the electrophotographic material while the electrophotographic material passes through the press-contacting portion between the heat roller 71 and the pressurizing roller 72.

Thereafter, the electrophotographic material, bearing the color toner image fixed in the image-receiving layer by heating the toner of the color toner image to a temperature of substantially from 120° C. to 130° C. at the press-contacting portion between the heat roller 71 and the pressurizing roller 72, is conveyed by the endless belt 73, while the toner image-receiving layer in the surface of electrophotographic material adheres to the surface of the endless belt 73. When conveying the electrophotographic image-receiving layer 18, the endless belt 73 is forcedly cooled by the cooling heatsink 77 and the color toner image and the image-receiving layer are cooled and solidified so that the electrophotographic image-receiving layer is peeled from the endless belt 73 by the peeling roller 74 and own stiffness (nerve) of the electrophotographic image-receiving layer.

The surface of the endless belt 73 after the peeling step is cleaned by removing residual toners therefrom using a cleaner (not shown) and readied for the next step of fixing the image and smoothing the image surface.

The inventive image recording method may form high-quality images far from occurrences of blister, uneven recording or uneven fixing, since the electrophotographic material having the inventive support for image recording material is employed.

### EXAMPLES

The present invention will be explained with reference to Examples, but the present invention should not be limited thereto.

### Example 1

### Production of Support for Image Recording Material

A broad-leaf kraft pulp (LBKP) was beaten to 340 ml of Canadian Standard Freeness using a conical refiner to prepare a pulp having an average fiber length of 0.63 mm. Three parts by mass of water-swellable carboxymethyl cellulose (etherification degree: 0.25, average particle diameter: 20 μm) was added to 100 parts by mass of the pulp and the mixture was stirred and dispersed.

Then 1.0% by mass of cationic starch, 0.5% by mass of alkylketene dimer (AKD) as a sizing agent, 0.2% by mass of anionic polyacrylamide, and 0.3% by mass of polyamide polyamine epichlorohydrin were added on the basis of mass of the pulp. The alkyl moiety of the alkylketene dimer is derived from an aliphatic acid based on behenic acid.

A raw paper of 160 g/m² was prepared from the pulp paper material using a Fourdrinier paper machine. In the process, 1.2 g/m² of carboxy-modified polyvinyl alcohol and 0.7 g/m² of CaCl₂ were deposited onto the front side of raw paper (where images being formed) at around the center of a drying zone of the Fourdrinier paper machine using a size press device.

At the last of the Fourdrinier paper machine, the density was adjusted to 0.98 g/cm³ by means of soft-calender treatment such that the front side (where images being formed) was treated by a metal roller of surface temperature 120° C. and the back side was treated by a resin roller of surface temperature 50° C.

The back side of the raw paper was then treated with corona discharge, followed by melting and co-extruding to coat a mixture of 30% by mass of LDPE and 70% by mass of high-density polyethylene (HDPE) in a film amount of 20 g/m², thereby to form a polyolefin resin layer at the back side.

Then the front side of the raw paper (where images being recorded) was treated with corona discharge, and two layers were coated on the front side in a way that a polypropylene (PP) resin containing 15% mass of titanium dioxide in a film amount of 10 g/m² as the first polyolefin resin layer of the lower layer and a low density polyethylene (LDPE) containing 15% mass of titanium dioxide in a film amount of 20 g/m² as the second polyolefin resin layer of the upper layer were melted and co-extruded by use of a co-extruding device.

In addition, an undercoat layer of gelatin was coated in an amount of 0.1 g/m² on the polyethylene resin layer at the front side. Consequently, the support for image recording material of Example 1 was prepared.

The treatment with corona discharge was carried out at an output of 0.010 kW/m²/min over the surface of the raw paper. The polyolefin layers described above were melted and extruded at 310° C., and ozone gas was applied at a concentration of 40 g/m³ onto the melted film of the polypropylene resin at the side to contact with the raw paper during the extruding process.

### Examples 2 to 11 and Comparative Examples 1 to 4

### Preparation of Support for Image Recording Material

Supports for image recording material of Examples 2 to 11 and Comparative Examples 1 to 4 were prepared in the same manner as Example 1, except that the first polyolefin resin layer (lower layer) and/or the second polyolefin resin layer (upper layer) were changed as shown in Table 2.

The supports of Comparative Examples 1 to 3 were of one layer of polymer coating layer with no second polyolefin resin layer (upper layer).

TABLE 2

| | First Polyolefin Resin Layer | | | Second Polyolefin Resin Layer | | |
|---|---|---|---|---|---|---|
| | (lower layer) | | | (upper layer) | | |
| | PP | LDPE | Film Mass | PP | LDPE | Film Mass |
| | (% by mass) | (% by mass) | (g/m²) | (% by mass) | (% by mass) | (g/m²) |
| Ex. 1 | 100% | 0% | 10 | — | 100% | 20 |
| Ex. 2 | 100% | 0% | 15 | — | 100% | 15 |
| Ex. 3 | 100% | 0% | 20 | — | 100% | 10 |
| Ex. 4 | 80% | 20% | 10 | — | 100% | 20 |
| Ex. 5 | 80% | 20% | 15 | — | 100% | 15 |
| Ex. 6 | 80% | 20% | 20 | — | 100% | 10 |
| Ex. 7 | 30% | 70% | 10 | — | 100% | 20 |
| Ex. 8 | 30% | 70% | 15 | — | 100% | 15 |
| Ex. 9 | 30% | 70% | 20 | — | 100% | 10 |
| Ex. 10 | 10% | 90% | 15 | — | 100% | 15 |
| Ex. 11 | 10% | 90% | 20 | — | 100% | 10 |
| Com. Ex. 1 | — | 100% | 30 | — | — | — |
| Com. Ex. 2 | 100% | — | 20 | — | — | — |
| Com. Ex. 3 | 100% | — | 30 | — | — | — |
| Com. Ex. 4 | — | 100% | 15 | 100% | — | 15 |

PP: polypropylene resin,
MFR: 42 g/10 minutes,
resin density: 0.905 g/cm³
LDPF: low density polyethylene,
MFR: 3.5 g/10 minutes,
resin density: 0.924 g/cm³

### Examples 12 to 22 and Comparative Examples 5 to 8

Electrophotographic image-receiving papers of Examples 12 to 22 and Comparative Examples 5 to 8 were prepared from the supports for image recording material of Examples 1 to 11 and Comparative Examples 1 to 4 in accordance with the following processes.

### Dispersion of Titanium Dioxide

A dispersion of titanium dioxide (content of titanium dioxide pigment: 40% by mass) was prepared by way of mixing 40.0 g of titanium dioxide (TIPAQUE® A-220, by Ishihara Sangyo Kaisha, Ltd.), 2.0 g of polyvinyl alcohol (PVA102, by Kuraray Co.) and 58.0 g of deionized water and dispersing the mixture using a mixer NBK-2 (by Nissei Co.).

### Preparation of Coating Liquid for Toner Image-Receiving Layer

A coating liquid for toner image-receiving layer was prepared by way of mixing 15.5 g of the dispersion of titanium dioxide described above, 15.0 g of a carnauba wax dispersion (Cellosol 524, by Chukyo Yushi Co.), 100.0 g of a polyester resin aqueous dispersion (solid content: 30% by mass, KZA-7049, by Unitika Ltd.), 2.0 g of a thickening agent (ALKOX E30, by Meisei Chemical Works, Ltd.), 0.5 g of an anionic surfactant (AOT), and 80 ml of deionized water and stirring the mixture.

The viscosity of the resulting coating liquid for toner image-receiving layer was 40 mPa·s and the surface tension was 34 mN/m.

### Preparation of Coating Liquid for Back Layer

A coating liquid for back layer was prepared by way of mixing 100.0 g of an acrylic resin aqueous dispersion (solid content: 30% by mass, Hi-Ros XBH-997L, by Seiko PMC Co.), 5.0 g of a matting agent (Techpolymer MBX-12, by Sekisui Plastics Co.), 10.0 g of a releasing agent (Hydrine D337, by Chukyo Yushi Co.), 2.0 g of a thickening agent, 0.5 g of an anionic surfactant (AOT), and 80 ml of deionized water and stirring the mixture.

The viscosity of the resulting coating liquid for back layer was 35 mPa·s and the surface tension was 33 mN/m.

### Coating of Back Layer and Toner Image-Receiving Layer

The coating liquid for back layer described above was coated using a bar coater in an amount of dry mass of 9 g/m² to the back side (where no toner image-receiving layer being disposed) of the supports for image recording material of Examples 1 to 5 and Comparative Examples 1 to 4, thereby to form the respective back layers.

The coating liquid for toner image-receiving layer described above was coated using a bar coater in an amount of dry mass of 12 g/m² to the front side, thereby to form the respective toner image-receiving layers. The content of the pigment in the toner image-receiving layer was 5% by mass based on the thermoplastic resin.

The back layer and the toner image-receiving layer were dried in an online manner by hot wind after coating thereof. In the drying process, the velocity and temperature of the drying wind were adjusted such that the back layer and the toner image-receiving layer were dried within two minutes after coating thereof. The dried point was assumed at the site where the temperature of the coated surface came to equivalent with the wet-bulb temperature of the drying wind.

After the drying, calender treatment was carried out using a gloss calender under a condition that the metal roller was maintained at 40° C. and the nip pressure was adjusted to 14.7 kN/cm² (15 kgf/cm²).

### Image Formation

The resulting electrophotographic image-receiving papers were cut into A4 size, and images were formed thereon using a full-color laser printer (DCC-500, by Fuji Xerox Co.) shown in FIG. 2, of which the fixing portion had been modified to change into the device configured to fix images and to smooth the image surface shown in FIG. 3, and the images were fixed and smoothed under the conditions shown below.

### Belt

support of belt: polyimide film (PI) of 50 cm wide and 80 μm thick

raw material of releasing layer of belt: SIFEL 610 (by Shin-Etsu Chemical Co.) of a precursor for fluorocarbon siloxane rubber was vulcanized and cured to form a fluorocarbon siloxane rubber layer of 50 μm thick

### Step of Heating and Pressing

temperature of heating roller: adjustable anyway as required

nip pressure: 130 N/cm²

### Step of Cooling

cooler: heatsink length 80 mm

conveying velocity: 53 mm/sec

The resulting electrophotographic prints were evaluated in terms of image quality, edge void, and blister in accordance with the following way. The results are shown in Table 3.

### Image Quality

The image quality of the electrophotographic prints was visually observed and evaluated in accordance with the following criteria.

### Evaluation Criteria

A: very excellent, available for high-quality image recording material

B: excellent, available for high-quality image recording material

C: middle, allowable for high-quality image recording material

D: inferior, inadequate for high-quality image recording material

### Evaluation of Edge Void (Defect Due to Poor Conformability)

The electrophotographic prints were visually observed in terms of defects that had generated at borderlines between toner image area and non-image area due to poor conformability at fixing temperature of 125° C., and evaluated in accordance with the following criteria.

### Evaluation Criteria

A: no defects

B: defects generated, but almost non-detectable

C: defects generated, somewhat detectable, practically non-problematic

D: many defects, significantly detectable

### Evaluation of Blister

The electrophotographic image-receiving papers were measured with respect to the temperature of the fixing belt at which blister initiates to generate, and evaluated in accordance with the following criteria. The higher is the temperature of the fixing belt means, the more excellent is the blister resistance.

### Evaluation Criteria

A: very excellent

B: excellent

C: somewhat inferior

D: very inferior

TABLE 3

| | | |
|---|---|---|
| Image | Edge Void | Blister |

| | Quality | Rank | Temp. | Evaluation |
|---|---|---|---|---|
| Ex. 12 | B | A | 130° C. | B |
| Ex. 13 | A | A | 145° C. | A |
| Ex. 14 | A | B | 145° C. | A |
| Ex. 15 | B | A | 130° C. | B |
| Ex. 16 | A | A | 140° C. | A |
| Ex. 17 | A | B | 140° C. | A |
| Ex. 18 | C | A | 125° C. | C |
| Ex. 19 | A | A | 140° C. | A |
| Ex. 20 | B | B | 140° C. | A |
| Ex. 21 | C | A | 125° C. | C |
| Ex. 22 | A | A | 135° C. | A |
| Com. Ex. 5 | D | A | 120° C. | D |
| Com. Ex. 6 | D | D | 140° C. | A |
| Com. Ex. 7 | D | D | 145° C. | A |
| Com. Ex. 8 | D | D | 120° C. | D |

The results of Tables 2 and 3 demonstrate that the inventive image recording materials of Examples 12 to 22, which use the inventive supports for image recording material of Examples 1 to 11 where the content A of polypropylene resin in the lower layer is higher than the content B of polypropylene resin in the upper layer, lead to record high quality images with excellent blister resistance and free from occurrences of uneven recording or uneven fixing. In particular, the image recording materials of Examples 13, 16 and 19, which use the supports for image recording material of Examples 2, 5 and 8 where the film mass of the layer containing the polypropylene resin is 15 g/m² or more, the content A of polypropylene resin within the layer is 30% by mass or more, and the film mass of the outermost polypropylene resin layer at the front side is 15 g/m² or more, could record high-quality images with particularly excellent blister resistance and effective prevention for occurrences of uneven recording or uneven fixing. Among them, Example 13, where the content A of polypropylene resin being 100% by mass, provides appropriately useful images with most excellent blister resistance and effective prevention for occurrences of uneven recording or uneven fixing.

In contrast, the image recording materials of Comparative Examples 5 to 7, which use the supports for image recording material of Comparative Examples 1 to 3 where the polyolefin resin layer is mono-layer of low density polyethylene or polypropylene resin, could be superior in either blister resistance or prevention for occurrences of uneven recording and uneven fixing, but could be far from the both effects and thus high-quality images could not be recorded. The image recording material of Comparative Example 8, which uses the support for image recording material of Comparative Example 4 where the lower layer was LDPE, the upper layer was PP, and the content of polypropylene resin was larger in the upper layer than the lower layer, was inferior in the blister resistance and also in the prevention for occurrences of uneven recording or uneven fixing, and the image quality was poor.

### INDUSTRIAL APPLICABILITY

The inventive support for image recording material can record high-quality images far from occurrences of blister, uneven recording or uneven fixing, and thus can be advantageously available for various image recording materials, in particular for electrophotographic material, heat-sensitive material, sublimation transfer material, heat transfer material, heat development material, silver salt photographic material and ink-jet recording material.

The inventive image recording material utilizes the inventive support for image recording material, thus can be advantageously available for electrophotographic material, heat-sensitive material, sublimation transfer material, heat transfer material, heat development material, silver salt photographic material and ink-jet recording material.

1. A support for image recording material, comprising:
a raw paper, and
at least one polyolefin resin layer on both sides of the raw paper,
wherein two or more polyolefin resin layers are disposed at the front side where an image recording layer is to be disposed,
polypropylene resin is included within at least one polyolefin resin layer at the front side other than the outermost polyolefin resin layer at the front side, and
the content A (% by mass) of polypropylene resin within the at least one polyolefin resin layer at the front side other than the outermost polyolefin resin layer is higher than the content B (% by mass) of polypropylene resin within the outermost polyolefin resin layer at the front side.

2. The support for image recording material according to claim 1, used for recording an image by way of at least one of recording by heating, development by heating, and fixing by heating.

3. The support for image recording material according to claim 1, wherein the content A (% by mass) of polypropylene resin is higher than the content B (% by mass) of polypropylene resin by 10% by mass or more.

4. The support for image recording material according to claim 1, wherein the content A (% by mass) of polypropylene resin, within the polyolefin resin layer at the front side other than the outermost polyolefin resin layer at the front side, is 30% by mass or more.

5. The support for image recording material according to claim 1, wherein the film mass of the polyolefin resin layer at the front side, containing the polypropylene resin other than the outermost polyolefin resin layer at the front side, is 10 g/m² or more.

6. The support for image recording material according to claim 1, wherein the polypropylene resin has a melt flow rate of 18 g/10 minutes to 50 g/10 minutes and a resin density of 0.890 or more.

7. The support for image recording material according to claim 1, wherein at least one of the polyolefin resin layers contain at least one of organic pigments and inorganic pigments.

8. A method of producing the support for image recording material according to claim 1, comprising:
a surface-treating step for treating both sides of the raw paper at an output of no less than 0.010 kW/m²/min by way of corona discharge, plasma, or flame treatment, and
a melt-extrusion step for melting and extruding the polyolefin resin onto both sides of the surface-treated raw paper.

9. The method of producing the support for image recording material according to claim 8, wherein the temperature at melting and extruding the polyolefin resin is 280° C. to 315° C. and ozone gas is applied at a concentration of 10 g/m³ to 50 g/m³ onto the raw-paper side of the melting and extruding film, in the melt-extrusion step.

10. An image recording material, comprising the support for image recording material according to claim 1, and an image recording layer on the support.

11. The image recording material according to claim 10, subjected to at least one of recording by heating, development by heating, and fixing by heating.

12. The image recording material according to claim 10, selected from electrophotographic material, heat-sensitive material, sublimation transfer material, heat transfer material, heat development material, silver salt photographic material, and ink-jet recording material.

13. An image recording method, comprising an image recording step to record an image by way of heating a heat-sensitive recording material that comprises at least a heat-sensitive recording layer on the support for image recording material according to claim 1 by use one of thermal heads and laser lights.

14. An image recording method, comprising:
a latent image-recording step, in which a heat-development material, comprising the support for image recording material according to claim 1 and at least one of a photosensitive heat-sensitive recording layer and a heat-development photosensitive layer on the support, is exposed to record a latent image, and
a heat development step, in which the exposed heat-development material is heated by use one of heating rollers, heating belts, plate heaters, thermal heads, laser lights, and combinations thereof to develop the latent image.

15. An image recording method, comprising:
a toner image-forming step, in which a toner image is formed on the electrophotographic material that comprises the support for image recording material according to claim 1 and a toner-image receiving layer, and
a heat fixing step, in which the toner image is fixed through heating by use of one of fixing rollers, fixing belts, and combinations thereof.

16. An image recording method, comprising:
a toner image-forming step, in which a toner image is formed on the electrophotographic material that comprises the support for image recording material according to claim 1 and a toner-image receiving layer, and
an image-surface smoothing-fixing step, in which the surface of the toner image is smoothed.

17. The image recording method according to claim 16, wherein the toner image is heated, pressed, cooled and peeled using an apparatus, configured to fix the toner image and to smooth the toner image surface, that is equipped with a heating-pressurizing unit, a belt, and a cooling unit, in the image-surface smoothing-fixing step.

18. The image recording method according to claim 17, wherein a layer containing fluorocarbon siloxane rubber is disposed at the surface of the belt.

19. The image recording method according to claim 17, wherein a layer containing silicone rubber is disposed at the surface of the belt, and a layer containing fluorocarbon siloxane rubber is disposed at the surface of the layer containing silicone rubber.

20. The image recording method according to claim 18, the fluorocarbon siloxane rubber comprises in its backbone chain at least one of perfluoroalkyl ether groups and perfluoroalkyl groups.
